(19) United States
(12) Patent Application Publication
(10) Pub. No.: US 2010/0228612 A1
(43) Pub. Date: Sep. 9, 2010

(54) DEVICE TRANSACTION MODEL AND SERVICES BASED ON DIRECTIONAL INFORMATION OF DEVICE

(75) Inventors: Moe Khosravy, Bellevue, WA (US); Lev Novik, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/400,087

(22) Filed: Mar. 9, 2009

(51) Int. Cl. G06Q 30/00; G01C 21/00

(52) U.S. Cl. 705/14.4; 701/207; 705/26

(57) ABSTRACT

With the addition of directional information in the environment, a variety of service(s) can be provided on top of user identification or interaction with specific object(s) of interest. For instance, when a user points at a particular item at a particular location or place, this creates an opportunity, e.g., an advertising opportunity, for anyone having an interest in that particular item to communicate with the user regarding that item or related items at a point in time when the user's focus is on the particular item. User context for the interaction can also be taken into account to supplement the provision of one or more interactive direction based services.

### TECHNICAL FIELD

The subject disclosure relates to mobile computing devices, and the provision of direction-based services based on direction information, and location, of the devices.

### BACKGROUND

By way of background concerning some conventional systems, mobile devices, such as portable laptops, PDAs, mobile phones, navigation devices, and the like have been equipped with location based services, such as global positioning system (GPS) systems, WiFi, cell tower triangulation, etc. that can determine and record a position of mobile devices. For instance, GPS systems use triangulation of signals received from various satellites placed in orbit around Earth to determine device position. A variety of map-based services have emerged from the inclusion of such location based systems that help users of these devices to be found on a map and to facilitate point to point navigation in real-time and search for locations near a point on a map.

However, such navigation and search scenarios are currently limited to displaying relatively static information about endpoints and navigation routes. While some of these devices with location based navigation or search capabilities allow update of the bulk data representing endpoint information via a network, e.g., when connected to a networked portable computer (PC) or laptop, such data again becomes fixed in time. Accordingly, it would be desirable to provide a set of richer experiences for users than conventional experiences predicated on location and conventional processing of static bulk data representing potential endpoints of interest.

The above-described deficiencies of today's location based systems and devices are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

Direction based pointing services are provided for portable devices or mobile endpoints. Mobile endpoints can include a positional component for receiving positional information as a function of a location of the portable electronic device, a directional component that outputs direction information as a function of an orientation of the portable electronic device and a processing engine that processes the positional information and the direction information to determine a subset of points of interest relative to the portable electronic device as a function of the positional information and/or the direction information.

Devices or endpoints can include compass(es), e.g., magnetic or gyroscopic, to determine a direction and location based systems for determining location, e.g., GPS. To supplement the positional information and/or the direction information, devices or endpoints can also include component(s) for determining speed and/or acceleration information for processing by the engine.

With the addition of directional information in the environment, a variety of service(s) can be provided on top of user identification or interaction with specific object(s) of interest. For instance, when a user points at a particular item at a particular location or place, this creates an opportunity for anyone having an interest in that particular item to communicate with the user regarding that item or related items at a point in time when the user's focus is on the particular item. User context for the interaction can also be taken into account to supplement the provision of one or more interactive direction based services.

These and other embodiments are described in more detail below.

### BRIEF DESCRIPTION OF THE DRAWINGS

Various non-limiting embodiments are further described with reference to the accompanying drawings in which:

FIG. 1 illustrates a block diagram of a non-limiting architecture for mobile device interaction scenarios in retail establishments;

FIG. 2 is a flow diagram of an exemplary non-limiting process for monetizing device interactions within retail establishments;

FIG. 3 illustrates a block diagram of a non-limiting implementation of a scenario in which special offers are retrieved for a device in a store;

FIG. 4 illustrates a block diagram of a non-limiting device architecture for pointing based services;

FIG. 5 is a flow diagram of an exemplary non-limiting process for providing advertising content from third parties within retail establishments;

FIG. 6 illustrates a block diagram of a non-limiting mobile scan scenario based on bar codes or imaging scan;

FIG. 7 illustrates a block diagram of a non-limiting advertising model consistent with various embodiments;

FIG. 8 illustrates a block diagram of various non-limiting ways to establish intent with a pointing enabled device as described herein;

FIG. 9 illustrates a block diagram of a non-limiting of advertising opportunities generated based on local searches constrained to a retail establishment;

FIG. 10 is a flow diagram of an exemplary non-limiting process for performing price comparisons within a retail establishment;

FIG. 11 illustrates a block diagram of a non-limiting embodiment in which a skinnable user interface is customizable by one or more content providers;

FIG. 12 illustrates a block diagram of a non-limiting device consistent with one or more embodiments described herein;

FIG. 13 is a flow diagram of an exemplary non-limiting process for using a device and services as described herein.

FIG. 14 is another flow diagram of an exemplary non-limiting process for using a device and services as described herein.

FIG. 15 is a block diagram showing a non-limiting embodiment in which information about how customers interact with points of interest inside a retail establishment is researched and exposed to third parties, e.g., to identify opportunities to improve user experiences for the retail establishment;

FIG. 16 is a block diagram illustrating the formation of motion vectors for use in connection with location based services;

FIG. 17, FIG. 18 and FIG. 19 illustrate aspects of algorithms for determining intersection endpoints with a pointing direction of a device;

FIG. 20 represents a generic user interface for a mobile device for representing points of interest based on pointing information;

FIG. 21 represents some exemplary, non-limiting alternatives for user interfaces for representing point of interest information;

FIG. 22 represents some exemplary, non-limiting fields or user interface windows for displaying static and dynamic information about a given point of interest;

FIG. 23 illustrates a sample overlay user interface for overlaying point of interest information over a camera view of a mobile device;

FIG. 24 illustrates a process for predicting points of interest and aging out old points of interest in a region-based algorithm;

FIG. 25 illustrates a first process for a device upon receiving a location and direction event;

FIG. 26 illustrates a second process for a device upon receiving a location and direction event;

FIG. 27 is a block diagram representing an exemplary non-limiting networked environment in which embodiment(s) may be implemented; and

FIG. 28 is a block diagram representing an exemplary non-limiting computing system or operating environment in which aspects of embodiment(s) may be implemented.

### DETAILED DESCRIPTION

### Overview

As discussed in the background, among other things, current location services systems and services, e.g., GPS, cell triangulation, P2P location service, such as Bluetooth, WiFi, etc., tend to be based on the location of the device only, and tend to provide static experiences that are not tailored to a user because the data about endpoints of interest is relatively static.

At least partly in consideration of these deficiencies of conventional location based services, various embodiments of a portable device are provided that enable users to point a device directionally and receive static and/or dynamic information in response from a networked service, such as provided by one or more servers, or as part of a cloud services experience. One or more embodiments described herein relate to advertising opportunities for given pre-defined 3-dimensional space(s) associated with a given entity, such as in a retail store.

In this regard, leveraging digital compasses and location services to provide direction and location information enables a next-generation of direction or pointer based location search services, scan services, discoverability services, etc., where the digital compass and GPS can be used to point at objects of interest, thus defining the entry point for one or more data transactions between the device and one or more third party devices providing service(s) for the objects of interest at which the device is pointed. Using a digital compass, e.g., solid state, magnetic, sun/moon based, etc. on a mobile endpoint facilitates point and upload scenarios, point and synchronize geographical information to a Web service, cloud services or another endpoint.

As reflected in various embodiments, a device is provided that can hone in on, interact with, or otherwise transact with, a specific object or specific objects of interest by way of location and direction of the device, creating a new advertising model not previously known. As an example, when a user interacts with a particular product on a shelf at a retail store in connection with a direction based service, this creates an opportunity for anyone having an interest in the particular product to engage the user, e.g., communicate some information to that user. Any context that can be discerned from the user's actions and interactions can also be taken into account when acting on the opportunity.

In this regard, users can interact with the endpoints in a host of context sensitive ways to provide or update information associated with endpoints of interest, or to receive beneficial information or instruments (e.g., coupons, offers, etc.) from entities associated with the endpoints of interest. With location services, it can be determined that a user's device is physically inside an actual store, or near a window display of a store. Coupling that to the user's interacting with an object of interest with direction-based services results in a new opportunity to take action based on the interaction.

In one embodiment, a portable electronic device is provided having a positional component for receiving position information as a function of a location of the portable electronic device; and at least one processor configured to process the position information to determine identifier(s) of three-dimensional (3-D) space(s) associated with the location of the portable electronic device and to request content based on intent information determined for the portable electronic device and the identifier(s).

The device can include a directional component that outputs direction information as a function of an orientation of the portable electronic device and that facilitates determining an intent of the device. The directional component can optionally be a digital compass that outputs the direction information. The device can determine a subset of items of interest relative to candidate items of interest within the 3-D space(s) as a function of the positional information or the direction information.

The device can request the content based on a selection of an item of interest and the identifier(s). The request for the content can be based on a scan of an encoding associated with an item of interest and the identifier(s). The request for the content can be based on a keyword received as input by the device and the identifier(s). The request for the content can be based on the intent information and the identifier(s) from at least one network service. The request for content can also be automatic.

The device then receives a content package based on the request for the content from the at least one network service. The device can optionally include a display or sound devices, such as speakers, to display or render some or all of the graphical (e.g., text, icon, image data, video data, etc.) and/or audio content of the content package.

In another embodiment, a method comprises determining place(s) in which a portable device is located based on location information determined for the device, the location information representing a position of the device, interacting with at least one item of interest in the place(s), requesting a price comparison for the at least one item of interest in the place(s) from a network service including requesting based on the place(s); and receiving results of the request for the price comparison modified as a function of the place(s).

The results can include at least one additional or modified price added or modified based on the place(s) or results adhering to price matching rule(s) for the place(s). The interacting can include a scanning of bar code(s) associated with the item(s) of interest. The interacting can include identifying item(s) of interest with keyword(s).

The interacting can include orientating the device toward the item(s) of interest and determining direction information associated with the orientation of the device. For instance, interacting can include pointing the device in a direction defining a pointing line generally towards items of interest in the place(s) and determining a set of candidate items of interest as a subset of items of interest that substantially intersect with the pointing line, and enabling the selection of one or more items from the set of candidate items.

In another embodiment, a method comprises receiving positional information measured by a device as a function of a location of the device, determining identifier(s) of at least one retail establishment associated with the positional information and based on the identifier(s), transmitting customized content associated with a brand of the at least one retail establishment to the device for display.

While each of the various embodiments herein are presented independently, e.g., as part of the sequence of respective Figures, one can appreciate that an integrated handset, as described, can incorporate or combine two or more of any of the embodiments. Given that each of the various embodiments improve the overall services ecosystem in which users wish to operate, together a synergy results from combining different benefits. Accordingly, the combination of different embodiments described below shall be considered herein to represent a host of further alternate embodiments.

Details of various other exemplary, non-limiting embodiments are provided below

### Mobile Scanning With Directional Information

With the addition of directional information in the environment, a variety of mobile scanning experiences are enabled on top of user identification of or interaction with specific object(s) of interest by pointing or otherwise gesturing at the object of interest. For instance, when a user points at a particular item at a particular location or place, this creates an opportunity for anyone having an interest in that particular item to communicate with the user regarding that item or related items at a point in time when the user's focus is on the particular item. User context for the interaction can also be taken into account to supplement the provision of one or more interactive direction based services.

In this regard, in various embodiments, mobile scanning or search scenarios are translated to advertising opportunities in particular places or locations as represented in 3-dimensional space. With the advent of mobile price comparison applications on mobile devices, such as mobile phones, brick and mortar stores are more and more being left out of transactions that they help originate. For instance, when a consumer uses a mobile device inside a store, a barcode to price compare, add to a list, look up information etc, the event(s) become an opportunity for the retailer to monetize the transaction. Instead, today, the retail establishments are losing out in the price comparisons (e.g., due to overhead of keeping inventory, staff, the actual real-estate, etc.) and thus falling behind the streamlined cost structure of a digital economy.

A pointer enabled device includes location and pointing capabilities to be able to know in what store the device is present based on location/orientation processing subsystems that augment the value added information on people, places and things, e.g., using client-to-cloud technologies. For example, a consumer in Best Buy may scan a BluRay player to find manuals, specs, reviews. The consumer may further request a price comparison, purchase of a player or addition to a wish list. This interaction taking place in the store is an opportunity for store and third parties alike to compete for the consumer's interest based on a context/intent of BluRay focus or scope.

Capturing this intent based on the device interaction and tying it to a location to facilitate a business model where “leads” generated inside a brick and mortar establishment are treated as advertising—creates an ecosystem where the consumer, the online retailer as well as the traditional retailer all win in the transaction and opportunity defined by the interaction.

In addition, offers and price comparisons for the local retailer are injected in the list of online/remote prices, enabling the retailer who creates the in store opportunity to be relevant in the price compare results. The transaction mechanism allows a dynamic model where the retailer can choose to present offers/lower prices within a percentage of the other advertised rates. For example, if a price compare from Amazon+Buy.com show a DVD for ˜$12-14, the brick and mortar establishment can automatically insert itself in the results of the price compare by lowering their price up to a previously established maximum discount for a more competitive posture for the potential transaction.

In this regard, as described in more detail below, items can be scanned in a brick and mortar establishment and treated as an advertising possibility, payable to the store and paid by the online retailer who took part in the traffic.

Advantageously, intent (as text, search, barcode scanning) coupled with location can be treated as a click through event analogous to click through or other eyeball based or premium form of advertising models due to the high relevancy. Similarly, a local search, e.g., a keyword search can be transacted as an advertisement opportunity payable to the store and paid by the online retailer.

Representing opportunity for the physical store itself, as mentioned, local offers can be inserted in price comparison results to give the physical store a competitive advantage over generic results. For example, the store can automatically match, e.g., to a percentage or other limit, the results of a price compare operation.

In addition, armed with information about the presence of a device in the store, a skinnable client UI can be customized taking advantage of the current store in which the device is present. For example: red user interface plus Target branding when inside a Target store, or Target watermarked logo overlaying the images presented, a background color consistent with the Target brand or other customizable parameter of the user interface corresponding to Target.

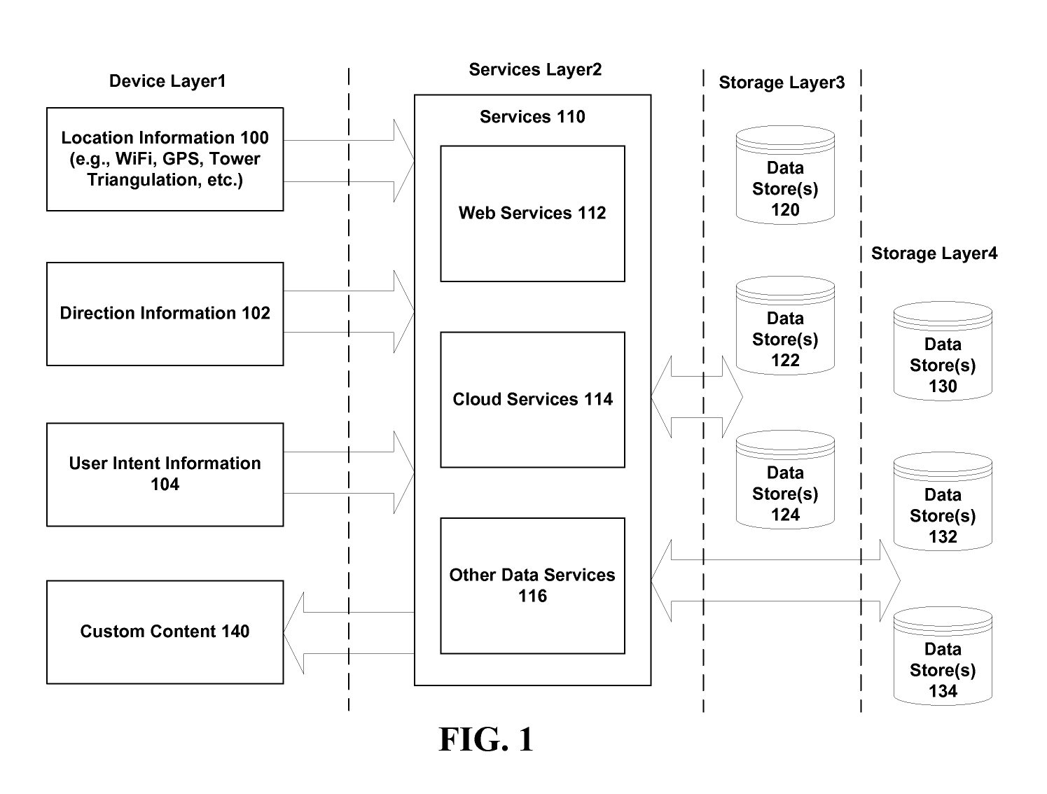

FIG. 1 is an exemplary non-limiting diagram of an architecture for achieving one or more embodiments described herein. At the device layer Layer1, location information 100, direction information 102 and user intent information 104 can be input to a Layer2 with various service 110, including web services 112, cloud services 114, other data services 116, etc. Any of services 110 can have input to a set of brick and mortar store databases in Layer3, such as data store(s) 120, 122, 124, etc. or set of online or electronic retailer databases in Layer4, such as data store(s) 130, 132, 134, etc. In this regard, user intent 104 coupled with a place of the device can be utilized by one or more services 110 to retrieve and deliver custom content 140 to the device based on the intent and place of the device.

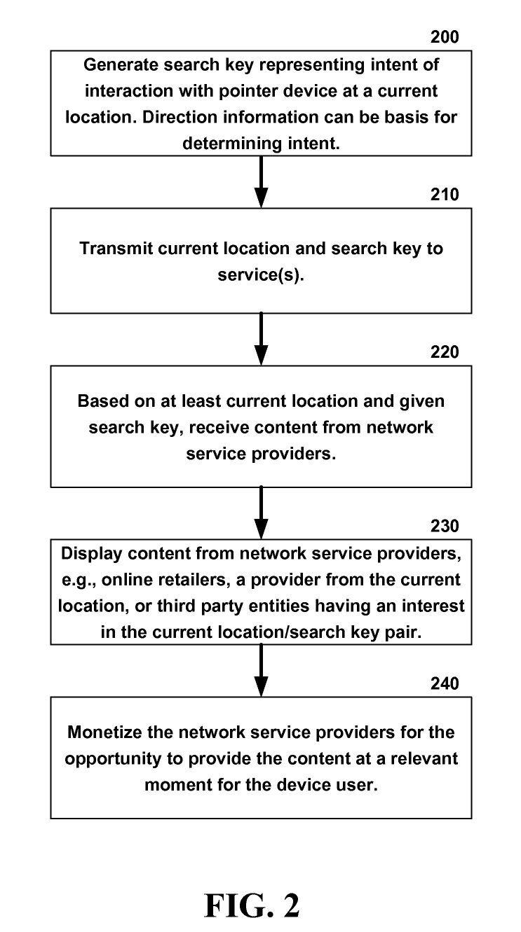

FIG. 2 is a flow diagram illustrating an exemplary sequence of actions of a non-limiting embodiment. At 200, a search key is generated representing an intent of interaction of pointer device at a current location with a given item in the place where the pointer device is. Direction information can be basis for determining intent. At 210, the current location or place, and search key are transmitted to service(s). At 220, based on at least current location and given search key, content is received from one or more interested network service providers. At 230, the requested content from network service providers, e.g., online retailers, is displayed. This can include a provider from the current location/place, or third party entities having an interest in the current location/search key pair. At 240, the network service providers interest provides for an opportunity to provide the content at a relevant moment for the device user in exchange for which a monetization can occur.

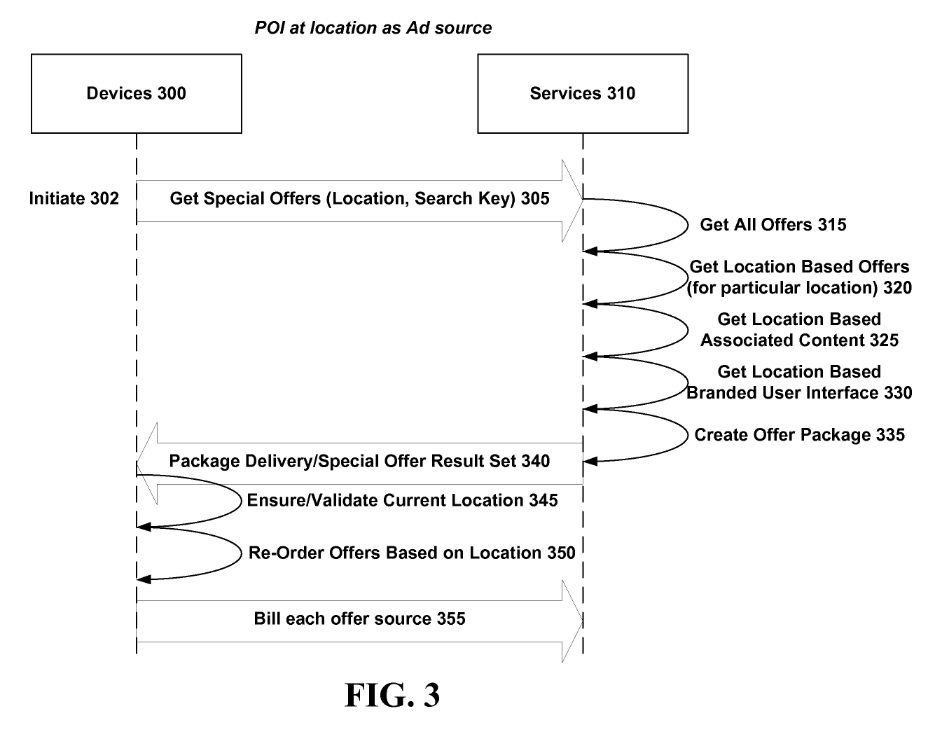

FIG. 3 is a block diagram illustrating an exemplary non-limiting implementation of an exchange between a device 300 and service 310. After start 302, an example request for illustrative purpose is made by a device 300 to a service 310, such as get special offers 305, which includes data related to the location of the device and a search key for use by the service in determining content for retrieval. For instance, then, at 315, the service 310 gets all offers, at 320, gets the offers for the given location. At 325, the service 310 may get content associated with the location along with an optional branded user interface at 330. At 335, a content package is created and delivered to the device 300 at 340. The device can undergo a check for the current location at 345. Optionally, the results can be modified, e.g., re-ordered at 350. Lastly, based on an advertising model, the content providers or owners can be billed at 355.

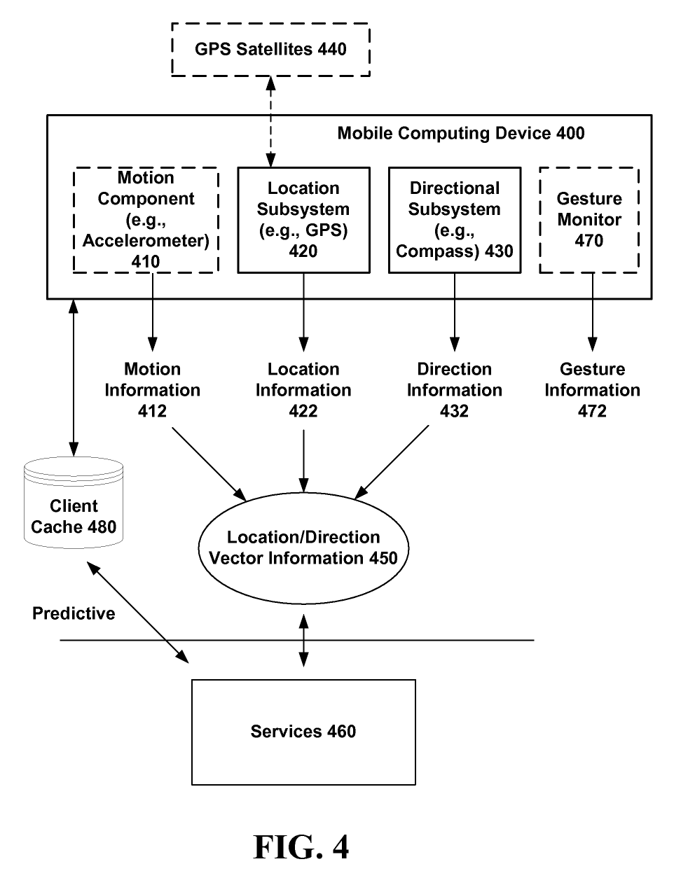

FIG. 4 illustrates a mobile computing device 100 according to an embodiment. In this regard, a set of services 460 can be built based on location information 422 and direction information 432 collected by a mobile device, such as a phone. For instance, location information 422 can be recorded by a location subsystem 420 such as a GPS subsystem communicating with GPS satellites 440. Direction or pointing information 432 can be collected by a direction subsystem 430, such as a compass, e.g., gyroscopic, magnetic, digital compass, etc. In addition, optionally, movement information 412 can be gathered by the device 400, e.g., via tower triangulation algorithms, and/or acceleration of the device 400 can be measured as well, e.g., with an accelerometer. The collective information 450 can be used to gain a sense of not only where the device 400 is located in relation to other potential points of interest tracked or known by the overall set of services 460, but also what direction the user is pointing the device 400, so that the services 460 can appreciate at whom or what the user is pointing the device 400.

In addition, a gesture subsystem 470 can optionally be included, which can be predicated on any one or more of the motion information 412, location information 422 or direction information 432. In this regard, not only can direction information 432 and location information 422 be used to define a set of unique gestures, but also motion information 412 (such as speed and acceleration) can be used to define a more sophisticated set of gestures.

FIG. 4 thus illustrates a gesture subsystem 470 can optionally be included in a device 400. In this regard, one can appreciate that a variety of algorithms could be adopted for a gesture subsystem 470. For instance, a simple click-event when in the “pointing mode” for the device 400 can result in determining a set of points of interest for the user.

In this respect, a device can include a variety of spatial and map components and intelligence to determine intersections for directional arcs. For instance, objects of interest could be represented with exact boundaries, approximated with spheres, subshells (stores in a mall) of a greater shell (mall), hierarchically arranged, etc. Dynamically generated bounding boxes can also be implemented work, i.e., any technique can be used to obtain boundary information for use in an intersection algorithm. Thus, such boundaries can be implicitly or explicitly defined for the POIs.

Thus, a device can include an intersection component that interprets pointing information relative to a set of potential points of interest. The engine can perform such intersections knowing what the resolution of the measuring instruments are on the device, such as a given resolution of a GPS system. Such techniques can include taking into account how far a user is from a plane of objects of interest, such as items on a shelf or wall, the size of the item of interest and how that is defined, as well as the resolution of location instrumentation, such as the GPS system. The device can also optionally include an altimeter, or any other device that gives altitude information, such as measuring radar or sonar bounce from the floor. The altitude information can supplement existing location information for certain specialized services where points of interest vary significantly at different altitudes. It is noted that GPS itself has some information about altitude in its encoding.

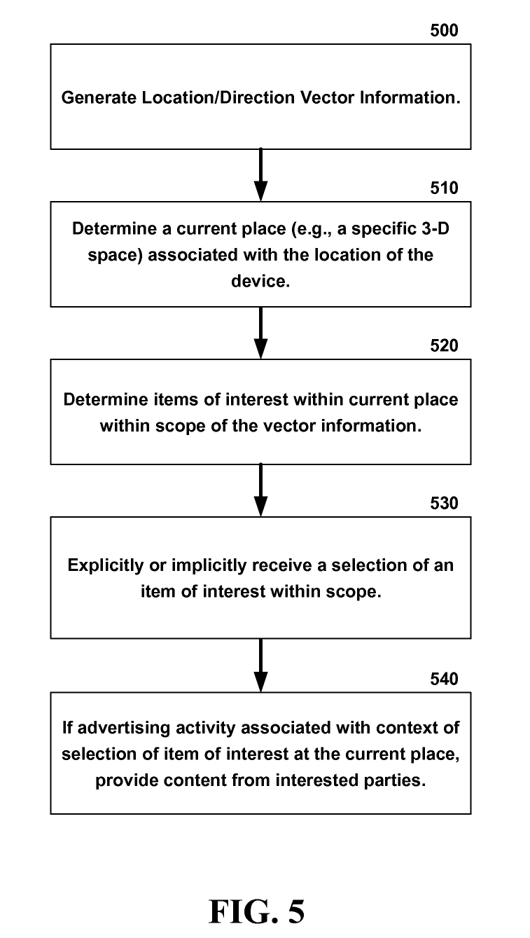

A representative interaction with a pointing device as provided in one or more embodiments herein is illustrated in FIG. 5. At 500, location/direction vector information is determined based on the device measurements. This information can be recorded so that a user's path or past can be used when predictively factoring what the user will be interested in next. At 510, a place is determined for the device based on at least location information. Based on the vector information, or more informally, the act of pointing by the user, at 520, an object or point of interest is selected based on any of a variety of “line of sight” algorithms that fall within or outside of the vector path. It is noted that occlusion culling techniques can optionally be used to facilitate overlay techniques. Whether the point of interest at issue falls within the vector can factor in the error in precision of any of the measurements, e.g., different GPS subsystems have different error in precision. In this regard, one or more items or points of interest may be found along the vector path or arc, within a certain distance depending on context, or within scope.

At 530, some action enables an explicit and/or implicit selection of an item of interest within scope. Then, any of a great variety of services can be performed with respect to any point of interest selected by the user via a user interface. In one aspect, at 540, interested parties can advertise based on the selection of the items of interest and parties can be compensated according to agreed upon advertising models.

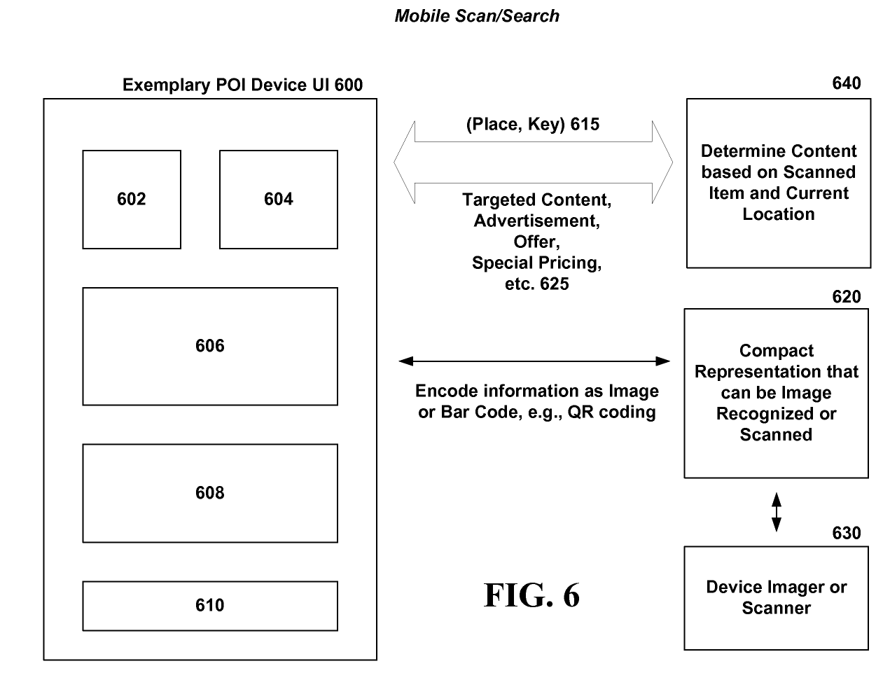

FIG. 6 illustrates a general block diagram for an optional encoding technique for the POI information of the various embodiments described herein. The idea is that the various pieces of static and dynamic information 602, 604, 606, 608, 610, etc. for a POI, which are normally represented as UI 600 on the device, can also be encoded as an image or a bar code 620, or some other device readable compact encoding. Then, a user can scan an item of interest, and coupled with presence in a physical store, a request 615 can be made to a service 640 with a key representing the scanned item and information representing the place, whereby the service 640 determines content 625 to return to the device 600 based on the scanned item and the place.

For instance, in an optional Quick Response (QR) support embodiment, decompression allows users to take pictures of a QR code and process its contents where information has been encoded into a sticker/printout for display outside of a business (e.g., in the form of a copyrighted URL). The code need not be a QR code, but could be any code that can be read or scanned or processed to determine its underlying content. For instance, with a visual representation, a picture can be taken and processed, or with the bar code, the device can scan it. RF identification technology could also be used. For the avoidance of doubt, any encoded image format can be used, like a bar code, only one example of which is a QR code.

In effect, this enables a query for POI information via a QR code or other encoding. The user scans or images the code with a device 630, and then transmits the code to the service, which translates the code into static and dynamically updated user information for display as a UI 600 (or other user interface representation) so that the user can query about a POI merely by pointing at it. A URL for the POI can also be encoded in a format such as a QR code. In one non-limiting embodiment, the user can point the device at a QR code, and decode a given image with the QR code.

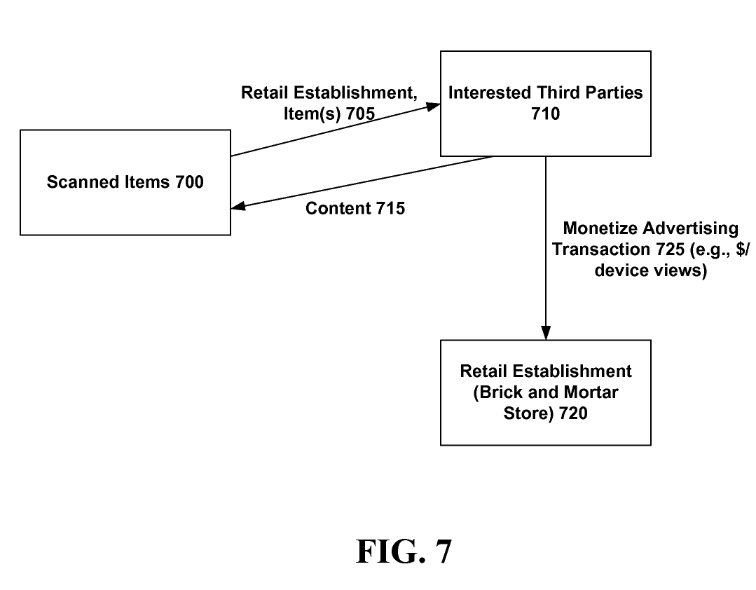

FIG. 7 illustrates at a high level, via a block diagram, the beneficial advertising model enabled by a direction/location based services enabled device as described in one or more embodiments herein. For instance, scanned items 700, or pointed to items 700, or any other action taken with respect to items 700 can be sent to a service that brokers interested third parties 710 who wish to advertise to a device given the place and particular items 700. Accordingly, such third parties 710 (third parties may be misleading because third parties can include parties related to the retail establishment itself) can provide content 715 tailored to that device event occurring in the retail establishment. That opportunity to advertise provided to the third parties 710 is therefore an opportunity to monetize 725 the transaction back to the original retail establishment 720. If the retail establishment is the third party, then naturally, the benefit can be provided without fee.

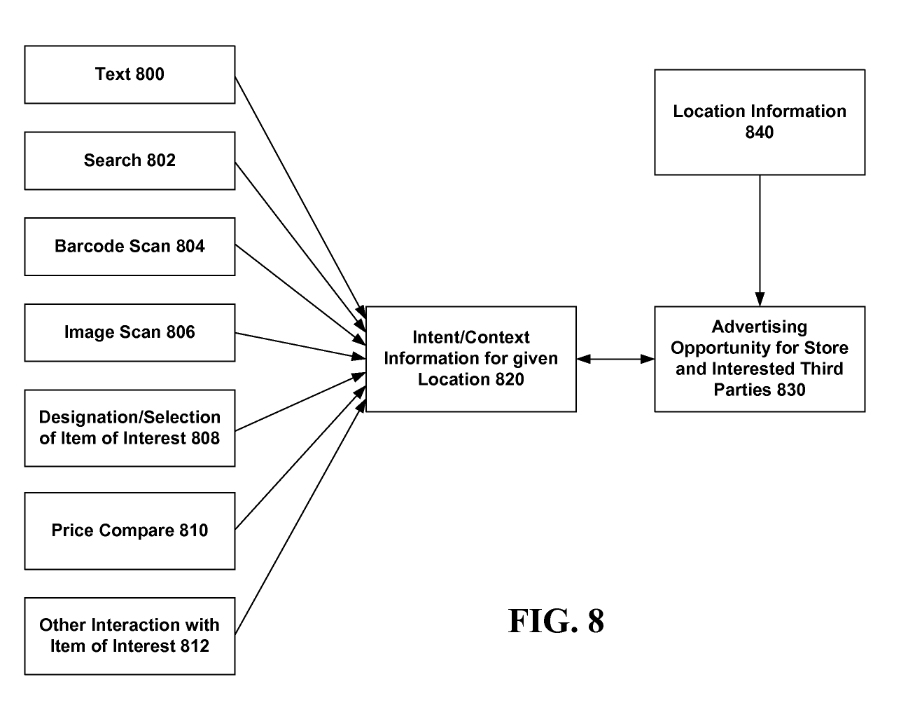

FIG. 8 is a block diagram illustrating the vast wealth of actions and interactions that can help define intent/context 820 for a given place in which the device is present. For instance, text 800 may be received by the device, a product search query 802 local to the store, bar code scan 804, image scan 806, explicit designation of a product (e.g., by pointing at a product, or taking an image of the product and performing image recognition) 808, price compare request 810, other interaction 812, etc. can all be taken into account in discerning intent of the device at a given place. This combined with location information 840 for discerning the place in which the device is in results in advertising opportunities 830 for a whole host of third party advertising transactions for potential delivery to the device.

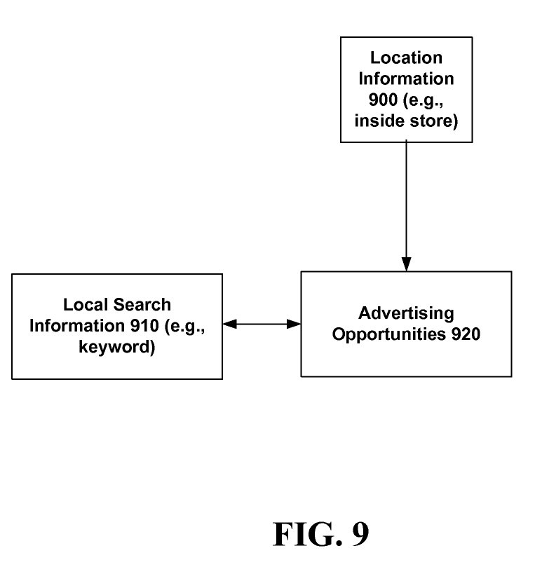

FIG. 9 is a block diagram illustrating a local search scenario where a device user may be looking for a hammer in a hardware store. In accordance with location information 900 that helps determine that the device is in the hardware store, and the local search information specified by a device user (e.g., keyword hammer), the fact that the device is in a hardware store and its owner is interested in the keyword hammer is an advertising opportunity for both the store owner and for external entities to exploit consistent with one or more embodiments described herein.

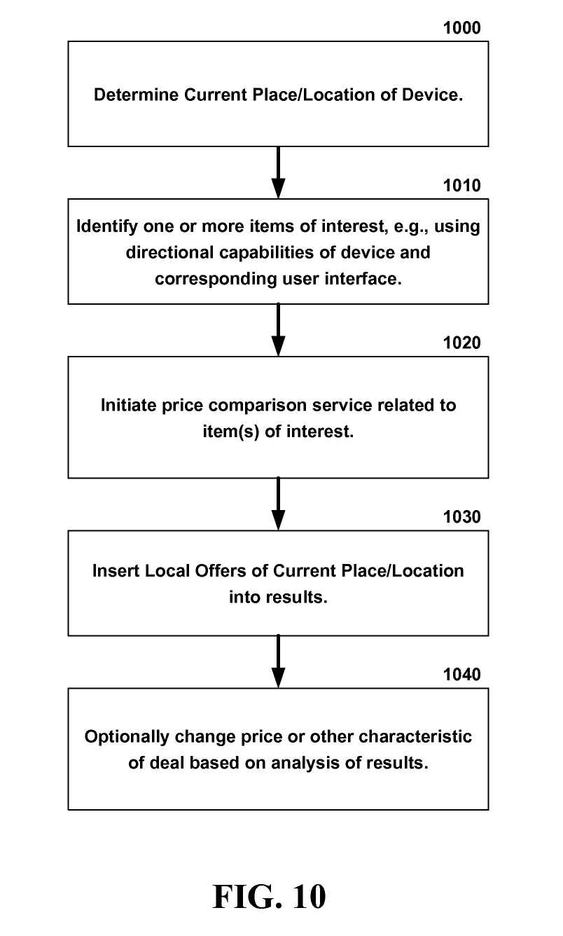

FIG. 10 is a flow diagram illustrating a process for a mobile device. At 1000, the current place/location of the device is discerned based on location information. At 1010, items of interest are identified by the device user, e.g., using directional capabilities of device and corresponding user interface. At 1020, a price comparison service is invoked related to item(s) of interest. At 1030, local offers are inserted into the prices results based on the current place. Optionally, at 1040, one or more prices, or other deal characteristic, can be changed based on an analysis of the results.

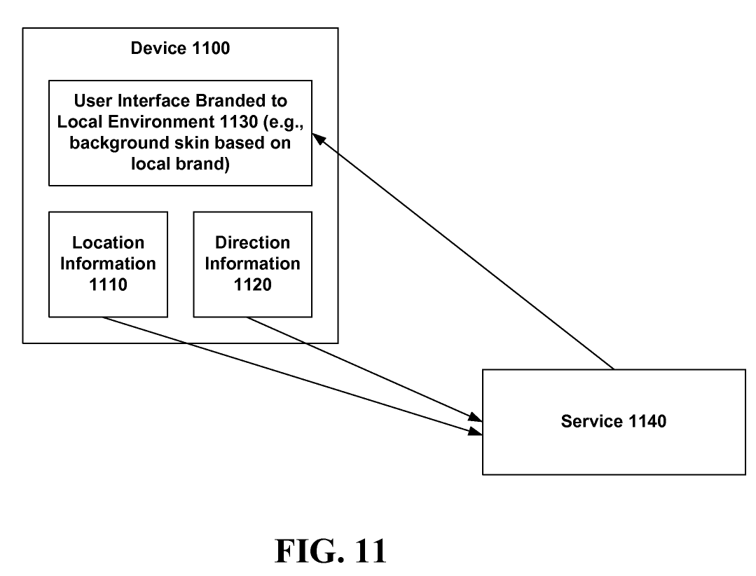

FIG. 11 is a block diagram illustrating an exemplary embodiment in which a skinnable user interface of the client can be customized to branding of the store in which the device is present. For instance, a device 1100 can interact with an item in a store, invoking a service 1140 as described in one or more embodiments herein. In this regard, based on location information 1110 and optionally direction information 1120, service 1140 returns a user interface branded to the local device environment 1130 (e.g., background skin based on local brand).

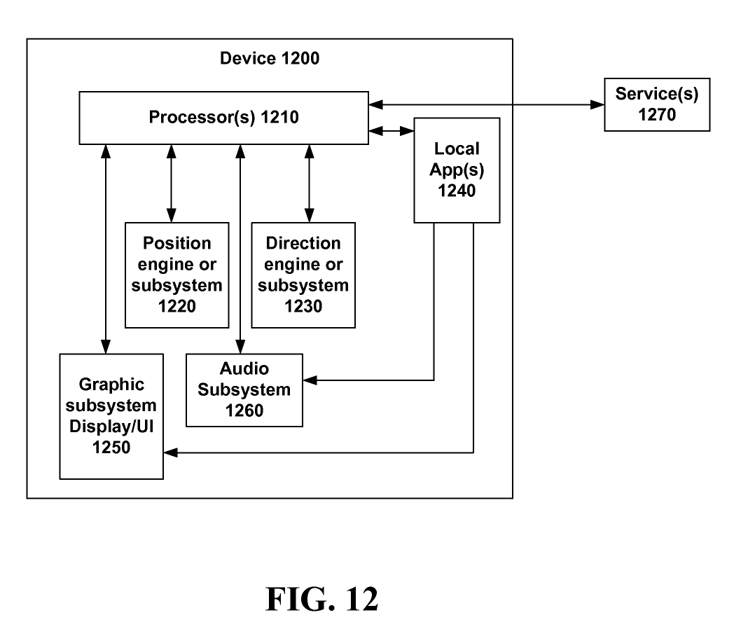

FIG. 12 illustrates an exemplary non-limiting device 1200 including processor(s) 1210 having a position engine or subsystem 1220 for determining a location of the device 1200 and a direction engine or subsystem 1230 for determining a direction or orientation of the device 1200. Then, by interacting with local application(s) 1240 and/or service(s) 1270, content can be delivered to the device, which is tailored to device intent and a place in which the device is present. The tailored content can be rendered by graphic subsystem or display/UI 1250 or audio Subsystem 1260.

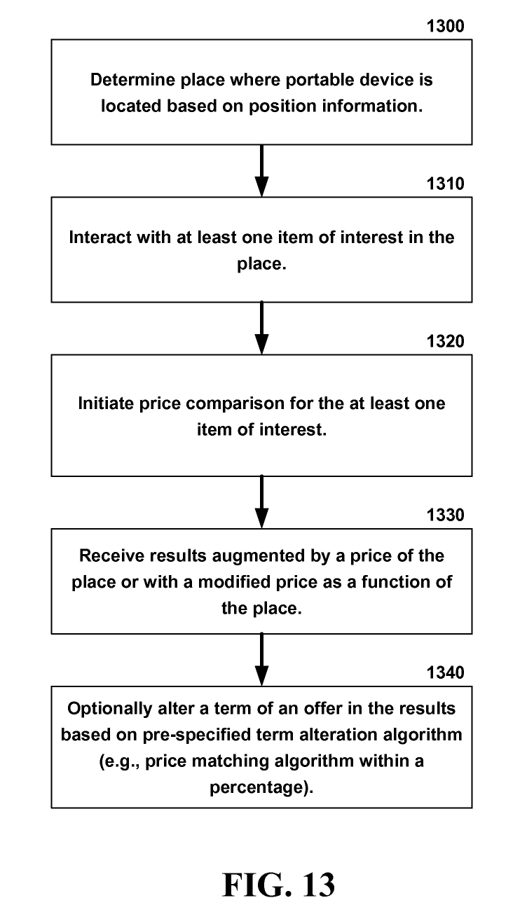

FIG. 13 is a flow diagram of an exemplary non-limiting process for using a device and services as described herein. At 1300, one or more places where a portable device is located based on position information is determined. At 1310, the device interacts with at least one item of interest in the place. At 1320, a price comparison is initiated for the at least one item of interest. At 1330, results of the price comparison request are augmented by a price of the place or with a modified price as a function of the place. Optionally, at 1340, a term of an offer in the results (e.g.,) a price can be altered based on pre-specified term alteration algorithm (e.g., price matching algorithm within a percentage).

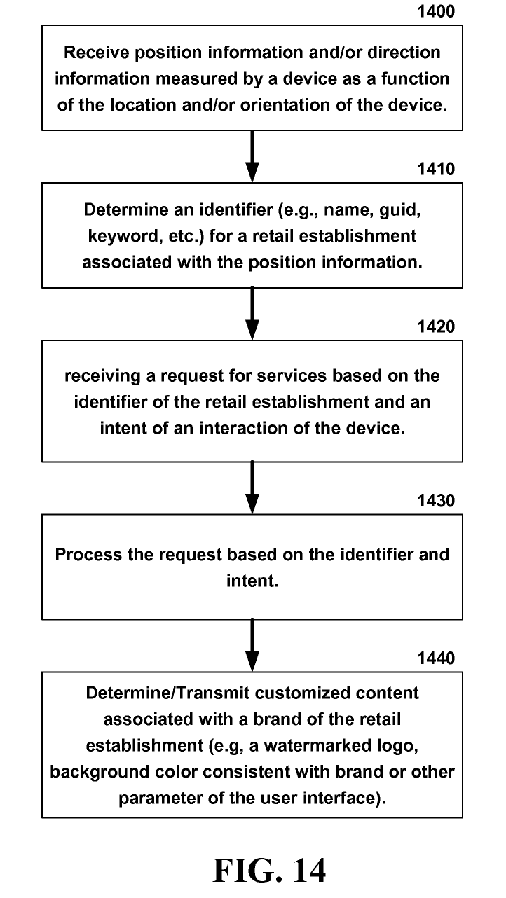

FIG. 14 is a flow diagram of another exemplary non-limiting process for using a device and services as described herein. At 1400, position information and/or direction information, measured by a device as a function of the location and/or orientation of the device, is received. At 1410, an identifier (e.g., name, guid, keyword, etc.) is determined for a retail establishment associated with the position information. At 1420, a request for services based on the identifier of the retail establishment and an intent of an interaction of the device is received by a service. At 1430, the request is processed by the service based on the identifier and intent. At 1440, customized content associated with a brand of the retail establishment is determined and transmitted back to the device. For example, examples of customized content based on a brand includes, but is not limited to, a watermarked logo, background color consistent with brand or other parameter of the user interface, etc.

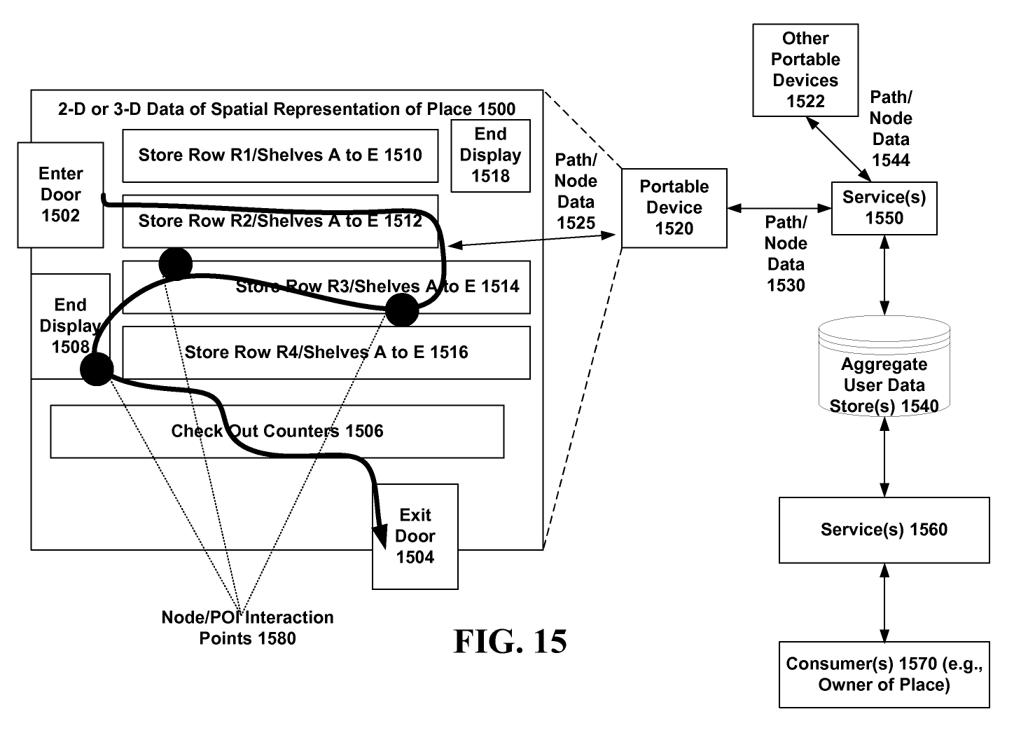

FIG. 15 is a block diagram illustrating an exemplary research or data analysis scenario or service that can leverage information about how devices interact within a given retail environment. Information about customers interaction (e.g., how, when, why, in what order) with points of interest inside a retail establishment can be aggregated and analyzed to determine patterns of user interactive behavior. For instance, with respect to a representation of a place 1500, which can be a 2-D representation, 3-D representation, coordinate data, segment data, vertex data, etc., a system or service can analyze how devices move through a given place 1500. For example, path/node interaction data 1525 can be collected by a portable device 1520 and the path node data 1530 of the portable device 1520 and path/node data 1544 from other portable devices 1522 can be collected by a service 1550, which can include storage providers 1540. In turn, additional service(s) 1560 can be built on the analysis of such place-specific interactive data, and thereby expose useful information to desirous consumers 1570 of such data, e.g., the owner of the place represented by data 1500 to improve product positioning, or portable device 1520 to improve shopping user experience.

For instance, in the given example, the store represented by data 1500 has an entrance 1502, exit 1504, check out counters 1506, end displays 1508, 1518, and rows 1510, 1512, 1514, 1516. Knowing the floormap of a building and assets tagged with RFID or Bluetooth transmitters, a service and a client can work to identify expensive asset locations, movement of products, etc. Thus, one example of a useful service is the identification of hot spot locations 1580 within the store where users naturally flow, perhaps prompting the store owner to move the location of end display 1518. Or, the data can be exposed to shoppers to help better lead them according to their interests. For an example of further granularity in a 3-D representation, each of the rows R1, R2, R3, R4 can be represented at a shelf level A to E for five shelves, whereby the store can try different store configurations and optimize the positioning of products for sale across the different shelves.

### Supplemental Context Regarding Pointing Devices, Architectures and Services

The following description contains supplemental context regarding potential non-limiting pointing devices, architectures and associated services to further aid in understanding one or more of the above embodiments. Any one or more of any additional features described in this section can be accommodated in any one or more of the embodiments described above with respect to direction based services at a particular location. While such combinations of embodiments or features are possible, for the avoidance of doubt, no embodiments set forth in the subject disclosure should be considered limiting on any other embodiments described herein.

As mentioned, a broad range of scenarios can be enabled by a device that can take location and direction information about the device and build a service on top of that information. For example, by effectively using an accelerometer in coordination with an on board digital compass, an application running on a mobile device updates what each endpoint is “looking at” or pointed towards, attempting hit detection on potential points of interest to either produce real-time information for the device or to allow the user to select a range, or using the GPS, a location on a map, and set information such as “Starbucks—10% off cappuccinos today” or “The Alamo—site of . . . ” for others to discover. One or more accelerometers can also be used to perform the function of determining direction information for each endpoint as well. As described herein, these techniques can become more granular to particular items within a Starbucks, such as “blueberry cheesecake” on display in the counter, enabling a new type of sale opportunity.

Accordingly, a general device for accomplishing this includes a processing engine to resolve a line of sight vector sent from a mobile endpoint and a system to aggregate that data as a platform, enabling a host of new scenarios predicated on the pointing information known for the device. The act of pointing with a device, such as the user's mobile phone, thus becomes a powerful vehicle for users to discover and interact with points of interest around the individual in a way that is tailored for the individual. Synchronization of data can also be performed to facilitate roaming and sharing of POV data and contacts among different users of the same service.

In a variety of embodiments described herein, 2-dimensional (2D), 3-dimensional (3D) or N-dimensional directional-based search, discovery, and interactivity services are enabled for endpoints in the system of potential interest to the user.

In this regard, the pointing information and corresponding algorithms ultimately depend upon the assets available in a device for producing the pointing or directional information. The pointing information, however produced according to an underlying set of measurement components, and interpreted by a processing engine, can be one or more vectors. A vector or set of vectors can have a “width” or “arc” associated with the vector for any margin of error associated with the pointing of the device. A panning angle can be defined by a user with at least two pointing actions to encompass a set of points of interest, e.g., those that span a certain angle defined by a panning gesture by the user.

In one non-limiting embodiment, a portable electronic device includes a positional component for receiving positional information as a function of a location of the portable electronic device, a directional component that outputs direction information as a function of an orientation of the portable electronic device and a location based engine that processes the positional information and the direction information to determine a subset of points of interest relative to the portable electronic device as a function of at least the positional information and the direction information.

The positional component can be a positional GPS component for receiving GPS data as the positional information. The directional component can be a magnetic compass and/or a gyroscopic compass that outputs the direction information. The device can include acceleration component(s), such as accelerometer(s), that outputs acceleration information associated with movement of the portable electronic device. The use of a separate sensor can also be used to further compensate for tilt and altitude adjustment calculations.

In one embodiment, the device includes a cache memory for dynamically storing a subset of endpoints of interest that are relevant to the portable electronic device and at least one interface to a network service for transmitting the positional information and the direction information to the network service. In return, based on real-time changes to the positional information and direction/pointing information, the device dynamically receives in the cache memory an updated subset of endpoints that are potentially relevant to the portable electronic device.

For instance, the subset of endpoints can be updated as a function of endpoints of interest within a pre-defined distance substantially along a vector defined by the orientation of the portable electronic device. Alternatively or in addition, the subset of endpoints can be updated as a function of endpoints of interest relevant to a current context of the portable electronic device. In this regard, the device can include a set of Representational State Transfer (REST)-based application programming interfaces (APIs), or other stateless set of APIs, so that the device can communicate with the service over different networks, e.g., Wi-Fi, a GPRS network, etc. or communicate with other users of the service, e.g., Bluetooth. For the avoidance of doubt, the embodiments are in no way limited to a REST based implementation, but rather any other state or stateful protocol could be used to obtain information from the service to the devices.

The directional component outputs direction information including compass information based on calibrated and compensated heading/directionality information. The directional component can also include direction information indicating upward or downward tilt information associated with a current upward or downward tilt of the portable electronic device, so that the services can detect when a user is pointing upwards or downwards with the device in addition to a certain direction. The height of the vectors itself can also be taken into account to distinguish between an event of pointing with a device from the top of a building (likely pointing to other buildings, bridges, landmarks, etc.) and the same event from the bottom of the building (likely pointing to a shop at ground level), or towards a ceiling or floor to differentiate among shelves in a supermarket. A 3-axis magnetic field sensor can also be used to implement a compass to obtain tilt readings.

Secondary sensors, such as altimeters or pressure readers, can also be included in a mobile device and used to detect a height of the device, e.g., what floor a device is on in a parking lot or floor of a department store (changing the associated map/floorplan data). Where a device includes a compass with a planar view of the world (e.g., 2-axis compass), the inclusion of one or more accelerometers in the device can be used to supplement the motion vector measured for a device as a virtual third component of the motion vector, e.g., to provide measurements regarding a third degree of freedom. This option may be deployed where the provision of a 3-axis compass is too expensive, or otherwise unavailable.

In this respect, a gesturing component can also be included in the device to determine a current gesture of a user of the portable electronic device from a set of pre-defined gestures. For example, gestures can include zoom in, zoom out, panning to define an arc, all to help filter over potential subsets of points of interest for the user.

For instance, web services can effectively resolve vector coordinates sent from mobile endpoints into <x,y,z> or other coordinates using location data, such as GPS data, as well as configurable, synchronized POV information similar to that found in a GPS system in an automobile. In this regard, any of the embodiments can be applied similarly in any motor vehicle device. One non-limiting use is also facilitation of endpoint discovery for synchronization of data of interest to or from the user from or to the endpoint.

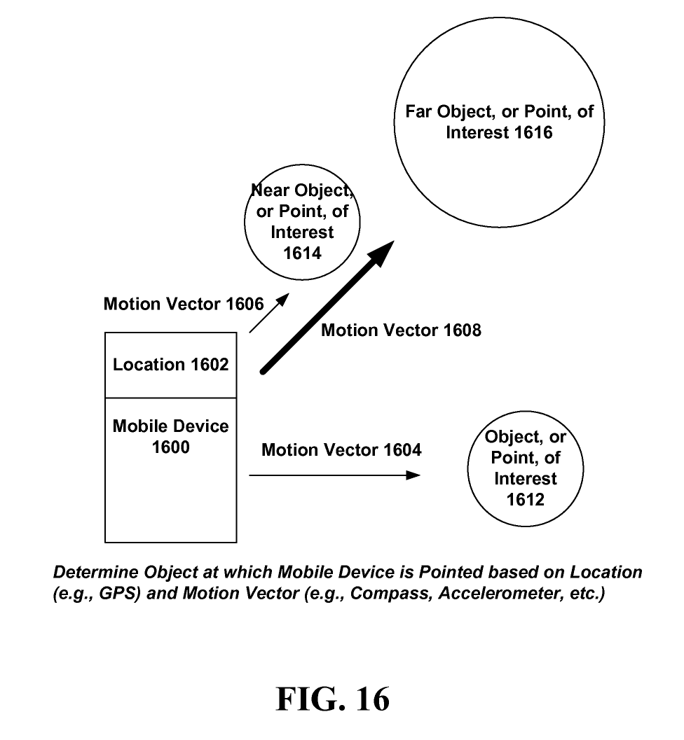

Among other algorithms for interpreting position/motion/direction information, as shown in FIG. 16, a device 1600 employing the direction based location based services 1602 as described herein in a variety of embodiments herein include a way to discern between near objects, such as POI 1614 and far objects, such as POI 1616. Depending on the context of usage, the time, the user's past, the device state, the speed of the device, the nature of the POIs, etc., the service can determine a general distance associated with a motion vector. Thus, a motion vector 1606 will implicate POI 1614, but not POI 1616, and the opposite would be true for motion vector 1608.

In addition, a device 1600 includes an algorithm for discerning items substantially along a direction at which the device is pointing, and those not substantially along a direction at which the device is pointing. In this respect, while motion vector 1604 might implicate POI 1612, without a specific panning gesture that encompassed more directions/vectors, POIs 1614 and 1616 would likely not be within the scope of points of interest defined by motion vector 1604. The distance or reach of a vector can also be tuned by a user, e.g., via a slider control or other control, to quickly expand or contract the scope of endpoints encompassed by a given “pointing” interaction with the device.

In one non-limiting embodiment, the determination of at what or whom the user is pointing is performed by calculating an absolute “Look” vector, within a suitable margin of error, by a reading from an accelerometer's tilt and a reading from the magnetic compass. Then, an intersection of endpoints determines an initial scope, which can be further refined depending on the particular service employed, i.e., any additional filter. For instance, for an apartment search service, endpoints falling within the look vector that are not apartments ready for lease, can be pre-filtered.

In addition to the look vector determination, the engine can also compensate for, or begin the look vector, where the user is by establish positioning (˜15 feet) through an A-GPS stack (or other location based or GPS subsystem including those with assistance strategies) and also compensate for any significant movement/acceleration of the device, where such information is available.

As mentioned, in another aspect, a device can include a client side cache of potentially relevant points of interest, which, based on the user's movement history can be dynamically updated. The context, such as geography, speed, etc. of the user can be factored in when updating. For instance, if a user's velocity is 2 miles an hour, the user may be walking and interested in updates at a city block by city block level, or at a lower level granularity if they are walking in the countryside. Similarly, if a user is moving on a highway at 60 miles per hour, the block-by-block updates of information are no longer desirable, but rather a granularity can be provided and predictively cached on the device that makes sense for the speed of the vehicle.

In an automobile context, the location becomes the road on which the automobile is travelling, and the particular items are the places and things that are passed on the roadside much like products in a particular retail store on a shelf or in a display. The pointing based services thus creates a virtual “billboard” opportunity for items of interest generally along a user's automobile path. Proximity to location can lead to an impulse buy, e.g., a user might stop by a museum they are passing and pointing at with their device, if offered a discount on admission.

In various alternative embodiments, gyroscopic or magnetic compasses can provide directional information. A REST based architecture enables data communications to occur over different networks, such as Wi-Fi and GPRS architectures. REST based APIs can be used, though any stateless messaging can be used that does not require a long keep alive for communicated data/messages. This way, since networks can go down with GPRS antennae, seamless switching can occur to Wi-Fi or Bluetooth networks to continue according to the pointing based services enabled by the embodiments described herein.

A device as provided herein according to one or more embodiments can include a file system to interact with a local cache, store updates for synchronization to the service, exchange information by Bluetooth with other users of the service, etc. Accordingly, operating from a local cache, at least the data in the local cache is still relevant at a time of disconnection, and thus, the user can still interact with the data. Finally, the device can synchronize according to any updates made at a time of re-connection to a network, or to another device that has more up to date GPS data, POI data, etc. In this regard, a switching architecture can be adopted for the device to perform a quick transition from connectivity from one networked system (e.g., cell phone towers) to another computer network (e.g., Wi-Fi) to a local network (e.g., mesh network of Bluetooth connected devices).

With respect to user input, a set of soft keys, touch keys, etc. can be provided to facilitate in the directional-based pointing services provided herein. A device can include a windowing stack in order to overlay different windows, or provide different windows of information regarding a point of interest (e.g., hours and phone number window versus interactive customer feedback window). Audio can be rendered or handled as input by the device. For instance, voice input can be handled by the service to explicitly point without the need for a physical movement of the device. For instance, a user could say into a device “what is this product right in front of me? No, not that one, the one above it” and have the device transmit current direction/movement information to a service, which in turn intelligently, or iteratively, determines what particular item of interest the user is pointing at, and returns a host of relevant information about the item.

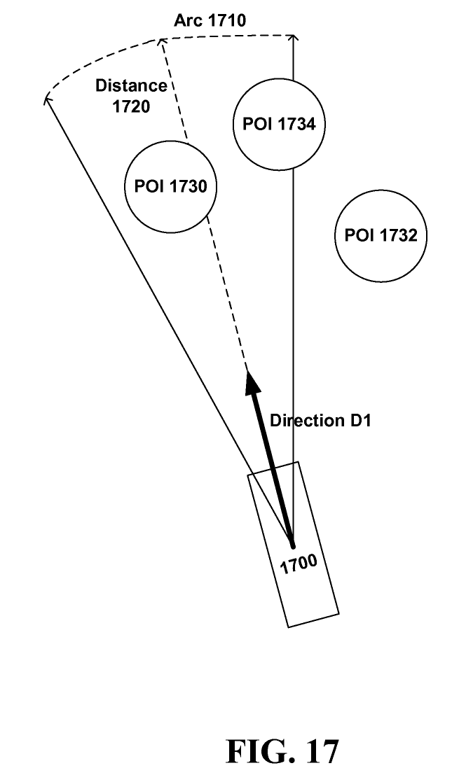

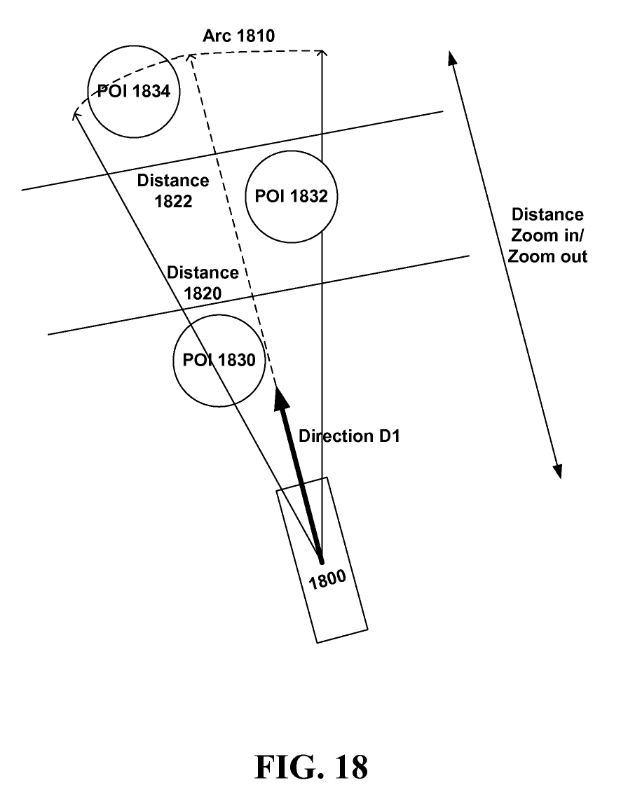

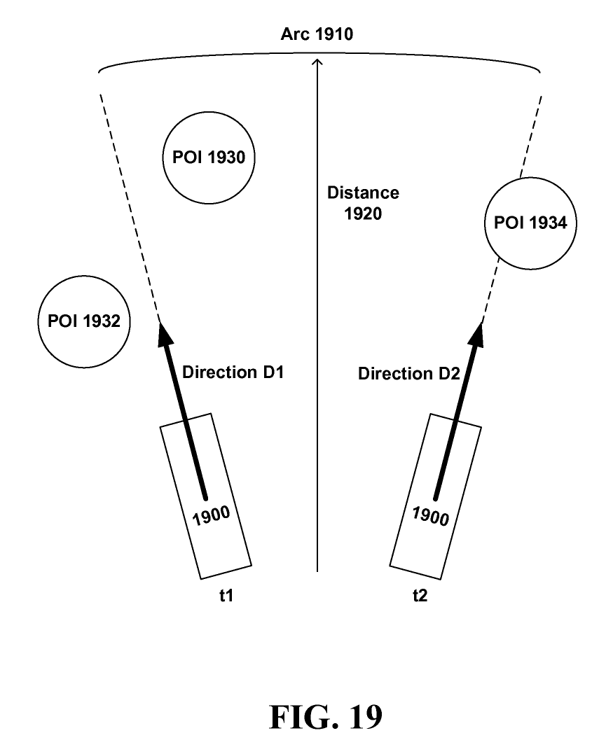

One non-limiting way for determining a set of points of interest is illustrated in FIG. 17. In FIG. 17, a device 1700 is pointed (e.g., point and click) in a direction D1, which according to the device or service parameters, implicitly defines an area within arc 1710 and distance 1720 that encompasses POI 1730, but does not encompass POI 1732. Such an algorithm will also need to determine any edge case POIs, i.e., whether POIs such as POI 1734 are within the scope of pointing in direction D1, where the POI only partially falls within the area defined by arc 1710 and distance 1720.

Other gestures that can be of interest in for a gesturing subsystem include recognizing a user's gesture for zoom in or zoom out. Zoom in/zoom out can be done in terms of distance like FIG. 18. In FIG. 18, a device 1800 pointed in direction D1 may include zoomed in view which includes points of interest within distance 1820 and arc 1810, or a medium zoomed view representing points of interest between distance 1820 and 1822, or a zoomed out view representing points of interest beyond distance 1822. These zoom zones correspond to POIs 1830, 1832 and 1834, respectively. More or less zones can be considered depending upon a variety of factors, the service, user preference, etc.

For another non-limiting example, with location information and direction information, a user can input a first direction via a click, and then a second direction after moving the device via a second click, which in effect defines an arc 1910 for objects of interest in the system as illustrated in FIG. 19. For instance, via first pointing act by the user at time t1 in direction D1 and a second pointing act at time t2 by the user in direction D2, an arc 1910 is implicitly defined. The area of interest implicitly includes a search of points of object within a distance 1920, which can be zoomed in and out, or selected by the service based on a known granularity of interest, selected by the user, etc. This can be accomplished with a variety of forms of input to define the two directions. For instance, the first direction can be defined upon a click-and-hold button event, or other engage-and-hold user interface element, and the second direction can be defined upon release of the button. Similarly, two consecutive clicks corresponding to the two different directions D1 and D2 can also be implemented.

Also, instead of focusing on real distance, zooming in or out could also represent a change in terms of granularity, or size, or hierarchy of objects. For example, a first pointing gesture with the device may result in a shopping mall appearing, but with another gesture, a user could carry out a recognizable gesture to gain or lose a level of hierarchical granularity with the points of interest on display. For instance, after such gesture, the points of interest could be zoomed in to the level of the stores at the shopping mall and what they are currently offering.

In addition, a variety of even richer behaviors and gestures can be recognized when acceleration of the device in various axes can be discerned. Panning, arm extension/retraction, swirling of the device, backhand tennis swings, breaststroke arm action, golf swing motions could all signify something unique in terms of the behavior of the pointing device, and this is to just name a few motions that could be implemented in practice. Thus, any of the embodiments herein can define a set of gestures that serve to help the user interact with a set of services built on the pointing platform, to help users easily gain information about points of information in their environment.

Furthermore, with relatively accurate upward and downward tilt of the device, in addition to directional information such as calibrated and compensated heading/directional information, other services can be enabled. Typically, if a device is ground level, the user is outside, and the device is “pointed” up towards the top of buildings, the granularity of information about points of interest sought by the user (building level) is different than if the user was pointing at the first floor shops of the building (shops level), even where the same compass direction is implicated. Similarly, where a user is at the top of a landmark such as the Empire State building, a downward tilt at the street level (street level granularity) would implicate information about different points of interest that if the user of the device pointed with relatively no tilt at the Statue of Liberty (landmark/building level of granularity).

Also, when a device is moving in a car, it may appear that direction is changing as the user maintains a pointing action on a single location, but the user is still pointing at the same thing due to displacement. Thus, thus time varying location can be factored into the mathematics and engine of resolving at what the user is pointing with the device to compensate for the user experience based upon which all items are relative.

Accordingly, armed with the device's position, one or more web or cloud services can analyze the vector information to determine at what or whom the user is looking/pointing. The service can then provide additional information such as ads, specials, updates, menus, happy hour choices, etc., depending on the endpoint selected, the context of the service, the location (urban or rural), the time (night or day), etc. As a result, instead of a blank contextless Internet search, a form of real-time visual search for users in real 3-D environments is provided.

In one non-limiting embodiment, the direction based pointing services are implemented in connection with a pair of glasses, headband, etc. having a corresponding display means that acts in concert with the user's looking to highlight or overlay features of interest around the user.

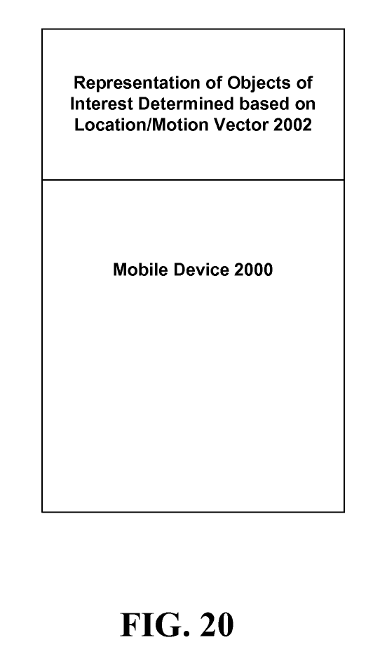

As shown in FIG. 20, once a set of objects is determined from the pointing information according to a variety of contexts of a variety of services, a mobile device 2000 can display the objects via representation 2002 according to a variety of user experiences tailored to the service at issue. For instance, a virtual camera experience can be provided, where POI graphics or information can be positioned relative to one another to simulate an imaging experience. A variety of other user interface experiences can be provided based on the pointing direction as well.

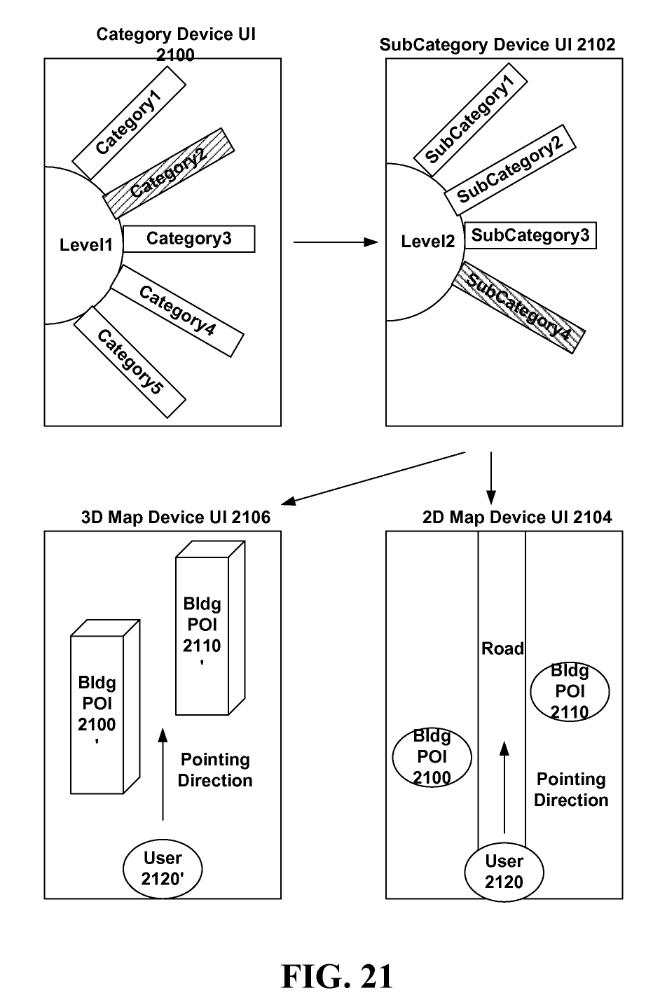

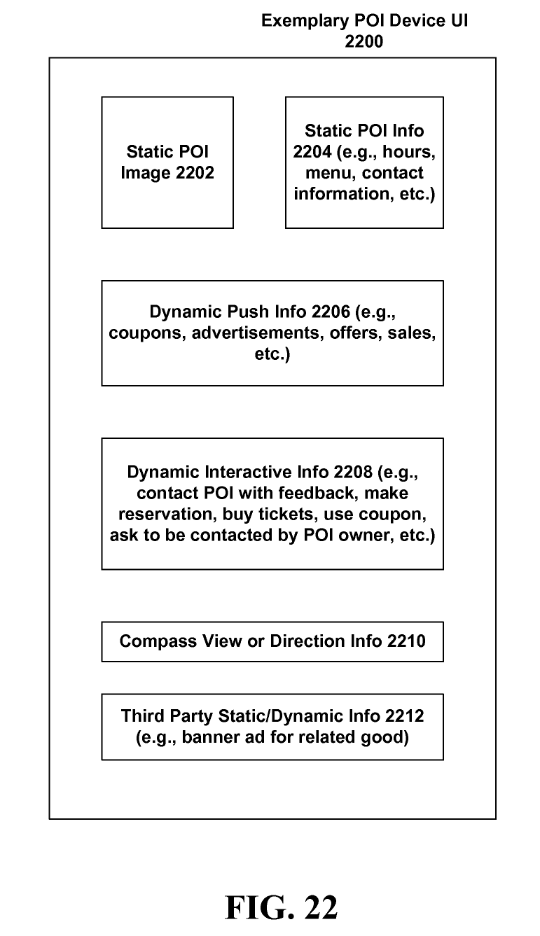

For instance, a set of different choices are shown in FIG. 21. UI 2100 and 2102 illustrate navigation of hierarchical POI information. For instance, level1 categories may include category1, category2, category3, category4 and category5, but if a user selects around the categories with a thumb-wheel, up-down control, or the like, and chooses one such as category2. Then, subcategory1, subcategory2, subcategory3 and subcategory4 are displayed as subcategories of category2. Then, if the user selects, for instance, subcategory4, perhaps few enough POIs, such as buildings 2100 and 2110 are found in the subcategory in order to display on a 2D map UI 2104 along the pointing direction, or alternatively as a 3D virtual map view 2106 along the pointing direction.

Once a single POI is implicated or selected, then a full screen view for the single POI can be displayed, such as the exemplary UI 2200. UI 2200 can have one or more of any of the following representative areas. UI 2200 can include a static POI image 2202 such as a trademark of a store, or a picture of a person. UI 2200 can also include other media, and a static POI information portion 2204 for information that tends not to change such as restaurant hours, menu, contact information, etc. In addition, UI 2200 can include an information section for dynamic information to be pushed to the user for the POI, e.g., coupons, advertisements, offers, sales, etc. In addition, a dynamic interactive information are 2208 can be included where the user can fill out a survey, provide feedback to the POI owner, request the POI to contact the user, make a reservation, buy tickets, etc. UI 2200 also can include a representation of the direction information output by the compass for reference purposes. Further, UI 2200 can include other third party static or dynamic content in area 2212.

When things change from the perspective of either the service or the client, a synchronization process can bring either the client or service, respectively, up to date. In this way, an ecosystem is enabled where a user can point at an object or point of interest, gain information about it that is likely to be relevant to the user, interact with the information concerning the point of interest, and add value to services ecosystem where the user interacts. The system thus advantageously supports both static and dynamic content.

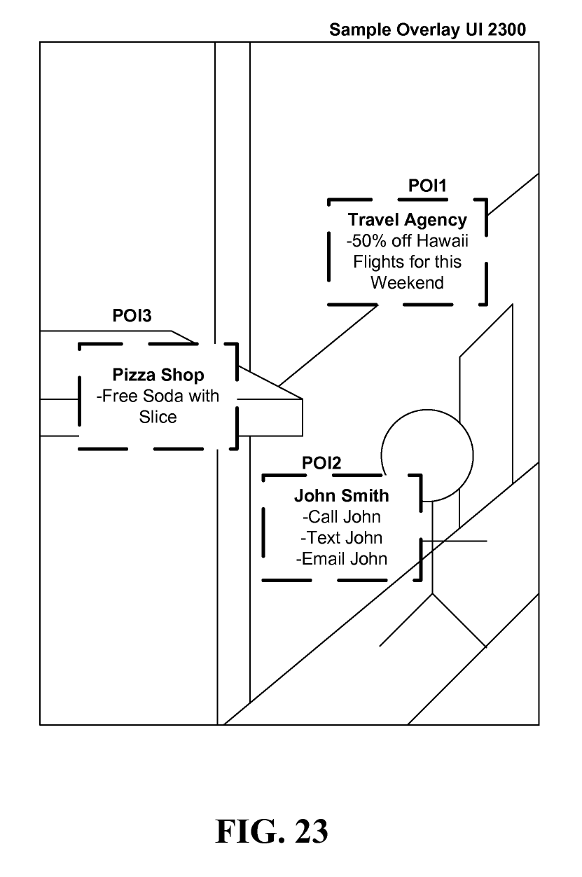

Other user interfaces can be considered such as left-right, or up-down arrangements for navigating categories or a special set of soft-keys can be adaptively provided.

Where a device includes a camera, in one embodiment shown in FIG. 23, a representative non-limiting overlay UI 2300 is shown having 3 POIs POI1, POI2 and POI3. The POIs are overlaid over actual image data being real time viewed on the device via an LCD screen or like display. The actual image data can be of products on a shelf or other display or exhibit in a store. Thus, as the user aims the camera around his or her environment, the lens becomes the pointer, and the POI information can be overlaid intelligently for discovery of endpoints of interest. Moreover, a similar embodiment can be imagined even without a camera, such as a UI in which 3-D objects are virtually represented based on real geometries known for the objects relative to the user. Thus, the device UI can be implemented consistent with a camera, or a virtual camera, view for intuitive use of such devices. The pointer mechanism of the device could also switch based on whether the user was currently in live view mode for the camera or not. Moreover, assuming sufficient processing power and storage, real time image processing could discern an object of interest and based on image signatures, overlay POI information over such image in a similar manner to the above embodiments. In this regard, with the device provided herein, a variety of gestures can be employed to zoom in zoom out, perform tilt detection for looking down or up, or panning across a field of view to obtain a range of POIs associated with the panning scope.

With respect to a representative set of user settings, a number or maximum number of desired endpoints delivered as results can be configured. How to filter can also be configured, e.g., 5 most likely, 5 closest, 5 closest to 100 feet away, 5 within category or sub-category, alphabetical order, etc. In each case, based on a pointing direction, implicitly a cone or other cross section across physical space is defined as a scope of possible points of interest. In this regard, the width or deepness of this cone or cross section can be configurable by the user to control the accuracy of the pointing, e.g., narrow or wide radius of points and how far out to search.

To support processing of vector information and aggregating POI databases from third parties, a variety of storage techniques, such as relational storage techniques can be used. For instance, Virtual Earth data can be used for mapping and aggregation of POI data can occur from third parties such as Tele Atlas, NavTeq, etc. In this regard, businesses not in the POI database will want to be discovered and thus, the service provides a similar, but far superior from a spatial relevance standpoint, Yellow Pages experiences where businesses will desire to have their additional information, such as menus, price sheets, coupons, pictures, virtual tours, etc. accessible via the system.

In addition, a synchronization platform or framework can keep the roaming caches in sync, thereby capturing what users are looking at and efficiently processing changes. Or, where a user goes offline, local changes can be recorded, and when the user goes back online, such local changes can be synchronized to the network or service store. Also, since the users are in effect pulling information they care about in the here and in the now through the act of pointing with the device, the system generates high cost per thousand impression (CPM) rates as compared to other forms of demographic targeting. Moreover, the system drives impulse buys, since the user may not be physically present in a store, but the user may be near the object, and by being nearby and pointing at the store, information about a sale concerning the object can be sent to the user.

As mentioned, different location subsystems, such as tower triangulation, GPS, A-GPS, E-GPS, etc. have different tolerances. For instance, with GPS, tolerances can be achieved to about 10 meters. With A-GPS, tolerances can be tightened to about 12 feet. In turn, with E-GPS, tolerance may be a different error margin still. Compensating for the different tolerances is part of the interpretation engine for determining intersection of a pointing vector and a set of points of interest. In addition, as shown in FIGS. 4-6, a distance to project out the pointing vector can be explicit, configurable, contextual, etc.

In this regard, the various embodiments described herein can employ any algorithm for distinguishing among boundaries of the endpoints, such as boundary boxes, or rectangles, triangles, circles, etc. As a default radius, e.g., 150 feet could be selected, and such value can be configured or be context sensitive to the service provided. On-line real estate sites can be leveraged for existing POI information. Since different POI databases may track different information at different granularities, a way of normalizing the POI data according to one convention or standard can also be implemented so that the residential real estate location data of Zillow can be integrated with GPS information from Starbucks of all the Starbucks by country.

In addition, similar techniques can be implemented in a moving vehicle client that includes GPS, compass, accelerometer, etc. By filtering based on scenarios (e.g., I need gas), different subsets of points of interest (e.g., gas stations) can be determined for the user based not only on distance, but actual time it may take to get to the point of interest. In this regard, while a gas station may be 100 yards to the right off the highway, the car may have already passed the corresponding exit, and thus more useful information to provide is what gas station will take the least amount of time to drive from a current location based on direction/location so as to provide predictive points of interest that are up ahead on the road, and not already aged points of interest that would require turning around from one's destination in order to get to them.

For existing motor vehicle navigation devices, or other conventional portable GPS navigation devices, where a device does not natively include directional means such as a compass, the device can have an extension slot that accommodates direction information from an external directional device, such as a compass. Similarly, for laptops or other portable electronic devices, such devices can be outfitted with a card or board with a slot for a compass. While any of the services described herein can make web service calls as part of the pointing and retrieval of endpoint process, as mentioned, one advantageous feature of a user's locality in real space is that it is inherently more limited than a general Internet search for information. As a result, a limited amount of data can be predictively maintained on a user's device in cache memory and properly aged out as data becomes stale.

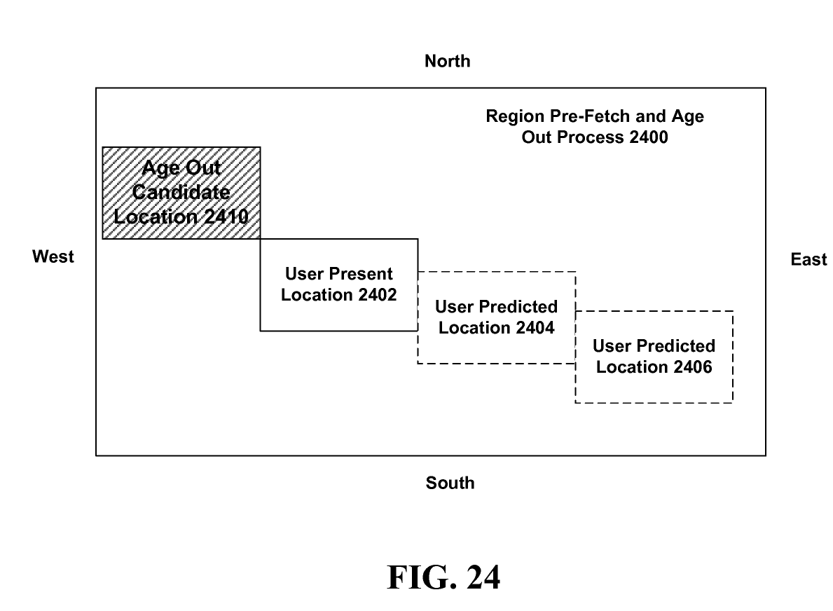

While there are a variety of implementations, and ways to sub-divide regions, whether overlapping or not, predictive caching and aging 2400 is conceptually illustrated by FIG. 24 in which a user's present location 2402 is discerned. At this point, the local cache still includes age out candidate location 2410, but as the velocity of the user indicates the user will be at predicted locations 2404 and 2406 in the future, these regions of POIs are downloaded to the mobile device. Accordingly, as the user travels to predicted location 2406, it starts to be clear that the user no longer needs the data from the age out candidate location 2410, which can then be removed, or flagged for removal when storage is challenged.

Accordingly, using the regional data cache, callbacks and an update mechanism that is updated dynamically based on movement, new point of interest can be added by a service or by a user. Update is thus performed continuously or substantially continuously based on updated travel, velocity, speed, etc. In this regard, a user can add a new point of interest in the region, add info to a local cache, and then upload to the zone. To appreciate the problem, the number of worldwide POIs is practically limitless, however only a small number of POIs will be relevant to a user at a given time. Thus, predictively, a cube of data can be taken to the device, the user can go offline such that when the user reconnects, the device is intelligent to figure out what has changed, been weighted, etc., so that the device can synchronize with the network services and expose the user's changes for other people.

The predictive algorithms again depend on what the user is interested in finding, what service the user may be using, the context of the user, etc. They can also be based on velocity, direction, time, etc. For instance, if it is nighttime, assumptions based on demographics or preferences may lead the device to return information about nightclubs or all night diners. Or, instead of giving directions as driving directions that calculate distances as absolute distances, i.e., as the crow flies, a device can take road curves into account since instantaneous pointing information on roads can be collected and handled by a corresponding service when giving driving directions. Or, as another alternative, the direction one is heading on a road, such as a highway with a concrete divider, is relevant to the directions that a navigation system should give. Where a U-turn is unavailable and user passes an exit with a point of interest, for instance, directions should take this into account and consider the heading of the vehicle.

Any device can include the embodiments described herein, including MP3 players, such as a Zune device, GPS navigation devices, bike computers, sunglass/visor systems, motor vehicles, mobile phones, laptops, PDA, etc.

One way to obtain the service applications, assuming the underlying measuring instruments to participate in the real-time gathering of directional information, is to message to a service to obtain the application, e.g., by text messaging to service, or getting a client download link. Another vehicle for enabling the service is to provide it natively in the operating system or applications of a mobile devices. Since a hardware abstraction layer accommodates different methods for collecting position, direction, acceleration information, the same platform can be used on any device regardless of the precise underlying hardware.

In another aspect of any of the embodiments described herein, because stateless messaging is employed, if communications drop with one network, the device can begin further communicating via another network. For instance, a device has two channels, and a user gets on a bus, but no longer have GPRS or GPS activity. Nonetheless the user is able to get the information the device needs from some other channel. Just because a tower, or satellites are down, does not mean that the device cannot connect through an alternative channel, e.g., the bus's GPS location information via Bluetooth.

With respect to exemplary mobile client architectures, a representative device can include, as described variously herein, client Side Storage for housing and providing fast access to cached POI data in the current region including associated dynamically updated or static information, such as annotations, coupons from businesses, etc. This includes usage data tracking and storage. In addition, regional data can be a cached subset of the larger service data, always updated based on the region in which the client is roaming. For instance, POI data could include as a non-limiting example, the following information:

POI coordinates and data //{−70.26322, 43.65412, “STARBUCK'S”}

Localized annotations //Menu, prices, hours of operation, etc

Coupons and ads //Classes of coupons (new user, returning, etc)

Support for different kinds of information (e.g., blob v structured information (blob for storage and media; structured for tags, annotations, etc.)

A device can also include usage data and preferences to hold settings as well as usage data such as coupons “activated,” waypoints, businesses encountered per day, other users encountered, etc. to be analyzed by the cloud services for business intelligence analysis and reporting.

A device can also include a continuous update mechanism, which is a service that maintains the client's cached copy of a current region updated with the latest. Among other ways, this can be achieved with a ping-to-pull model that pre-fetches and swaps out the client's cached region using travel direction and speed to facilitate roaming among different regions. This is effectively a paging mechanism for upcoming POIs. This also includes sending a new or modified POI for the region (with annotations+coupons), sending a new or modified annotation for the POIs (with coupons), or sending a new or modified coupon for the POI.

A device can also include a Hardware Abstraction Layer (HAL) having components responsible for abstracting the way the client communicates with the measuring instruments, e.g., the GPS driver for positioning and LOS accuracy (e.g., open eGPS), magnetic compass for heading and rotational information (e.g., gyroscopic), one or more accelerometers for gestured input and tilt (achieves 3D positional algorithms, assuming gyroscopic compass).

As described earlier, a device can also include methods/interfaces to make REST calls via GPRS/Wi-Fi and a file system and storage for storing and retrieving the application data and settings.

A device can also include user input and methods to map input to the virtual keys. For instance, one non-limiting way to accomplish user input is to have softkeys as follows, though it is to be understood a great variety of user inputs can be used to achieve interaction with the user interfaces of the pointing based services.

SK up/down: //Up and down on choices

SK right, SK ok/confirm: //Choose an option or drill down/next page

SK left, SK cancel/back, //Go back to a previous window, cancel

Exit/Incoming Call events //Exit the app or minimize

In addition, a representative device can include a graphics and windowing stack to render the client side UI, as well as an audio stack to play sounds/alerts.

As mentioned, such a device may also include spatial and math computational components including a set of APIs to perform 3D collision testing between subdivided surfaces such as spherical shells (e.g., a simple hit testing model to adopt and boundary definitions for POIs), rotate points, and cull as appropriate from conic sections.

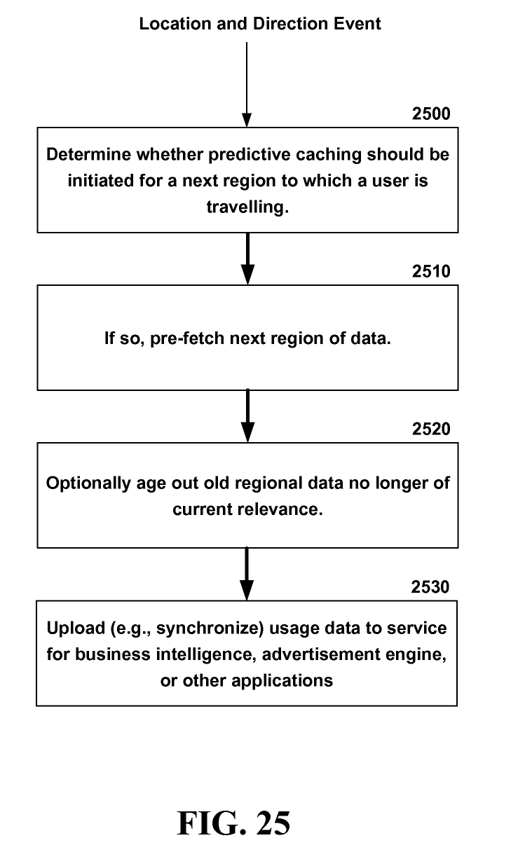

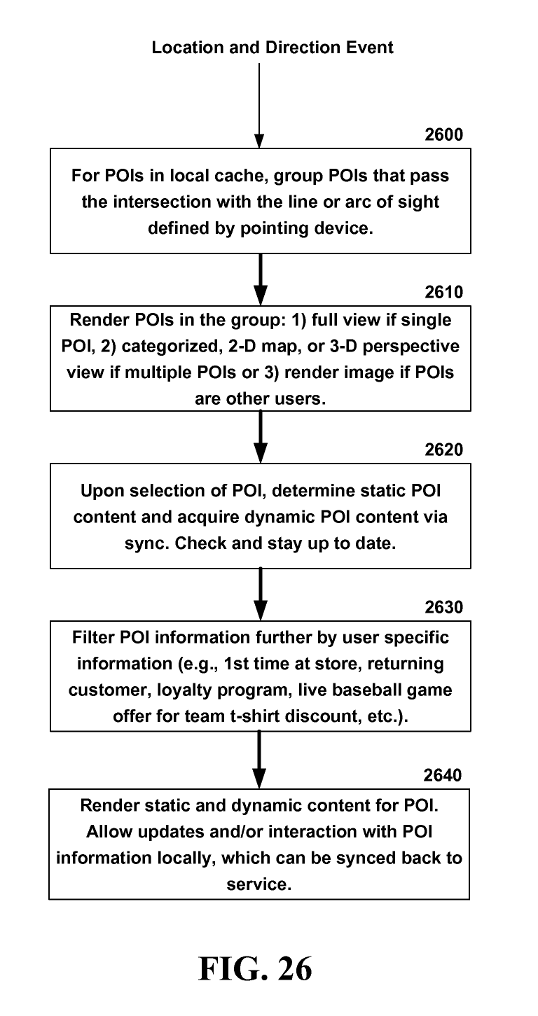

As described in various embodiments herein, FIGS. 25 and 26 illustrate two processes for a device when location (e.g., GPS) and direction (e.g., compass) events occur. In FIG. 25, upon the occurrence of a location or direction event, at 2500, it is determined whether predictive caching should be initiated for a next region to which a user is travelling. At 2510, if so, then the next region of data can be pre-fetched. At 2520, old regional data no longer of relevance can be aged out. At 2530, any usage data can be uploaded to the service framework for business intelligence, input to an advertisement engine, etc.

FIG. 26 represents another process for filtering potential POIs after a pointing event. Upon the detection of a location and direction event, at 2600, for POIs in the device's local cache, a group of POIs are determined that pass an intersection algorithm for the direction of pointing of the device. At 2610, POIs in the group can be represented in some fashion on a UI, e.g., full view if only 1 POI, categorized view, 2-D map view, 3-D perspective view, or user images if other users, etc. The possibilities for representation are limitless; the embodiments described herein are intuitive based on the general notion of pointing based direction services.

At 2620, upon selection of a POI, static content is determined and any dynamic content is acquired via synchronization. When new data becomes available, it is downloaded to stay up to date. At 2630, POI information is filtered further by user specific information (e.g., if it is the user's first time at the store, returning customer, loyalty program member, live baseball game offer for team clothing discounts, etc.). At 2640, static and dynamic content that is up to date is rendered for the POI. In addition, updates and/or interaction with POI information is allowed which can be synced back to the service.

### Exemplary Networked and Distributed Environments

One of ordinary skill in the art can appreciate that the various embodiments of methods and devices for pointing based services and related embodiments described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

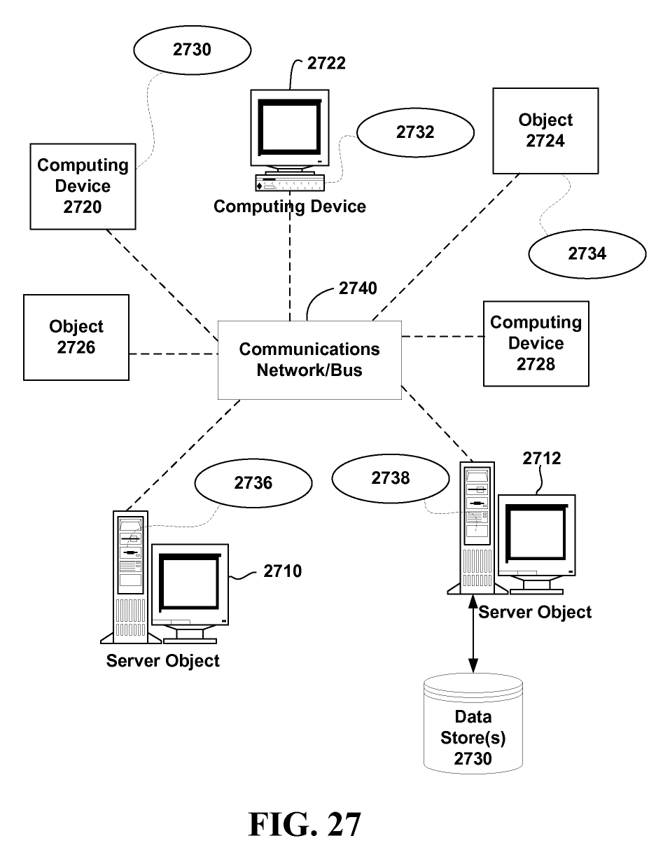

FIG. 27 provides a non-limiting schematic diagram of an exemplary networked or distributed computing environment. The distributed computing environment comprises computing objects 2710, 2712, etc. and computing objects or devices 2720, 2722, 2724, 2726, 2728, etc., which may include programs, methods, data stores, programmable logic, etc., as represented by applications 2730, 2732, 2734, 2736, 2738. It can be appreciated that objects 2710, 2712, etc. and computing objects or devices 2720, 2722, 2724, 2726, 2728, etc. may comprise different devices, such as PDAs, audio/video devices, mobile phones, MP3 players, laptops, etc.

Each object 2710, 2712, etc. and computing objects or devices 2720, 2722, 2724, 2726, 2728, etc. can communicate with one or more other objects 2710, 2712, etc. and computing objects or devices 2720, 2722, 2724, 2726, 2728, etc. by way of the communications network 2740, either directly or indirectly. Even though illustrated as a single element in FIG. 27, network 2740 may comprise other computing objects and computing devices that provide services to the system of FIG. 27, and/or may represent multiple interconnected networks, which are not shown. Each object 2710, 2712, etc. or 2720, 2722, 2724, 2726, 2728, etc. can also contain an application, such as applications 2730, 2732, 2734, 2736, 2738, that might make use of an API, or other object, software, firmware and/or hardware, suitable for communication with or implementation of the user profiling in a transaction and advertising platform as provided in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 27, as a non-limiting example, computers 2720, 2722, 2724, 2726, 2728, etc. can be thought of as clients and computers 2710, 2712, etc. can be thought of as servers where servers 2710, 2712, etc. provide data services, such as receiving data from client computers 2720, 2722, 2724, 2726, 2728, etc., storing of data, processing of data, transmitting data to client computers 2720, 2722, 2724, 2726, 2728, etc., although any computer can be considered a client, a server, or both, depending on the circumstances. Any of these computing devices may be processing data, or requesting services or tasks that may implicate the improved user profiling and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 2740 is the Internet, for example, the servers 2710, 2712, etc. can be Web servers with which the clients 2720, 2722, 2724, 2726, 2728, etc. communicate via any of a number of known protocols, such as the hypertext transfer protocol (HTTP). Servers 2710, 2712, etc. may also serve as clients 2720, 2722, 2724, 2726, 2728, etc., as may be characteristic of a distributed computing environment.

### Exemplary Computing Device

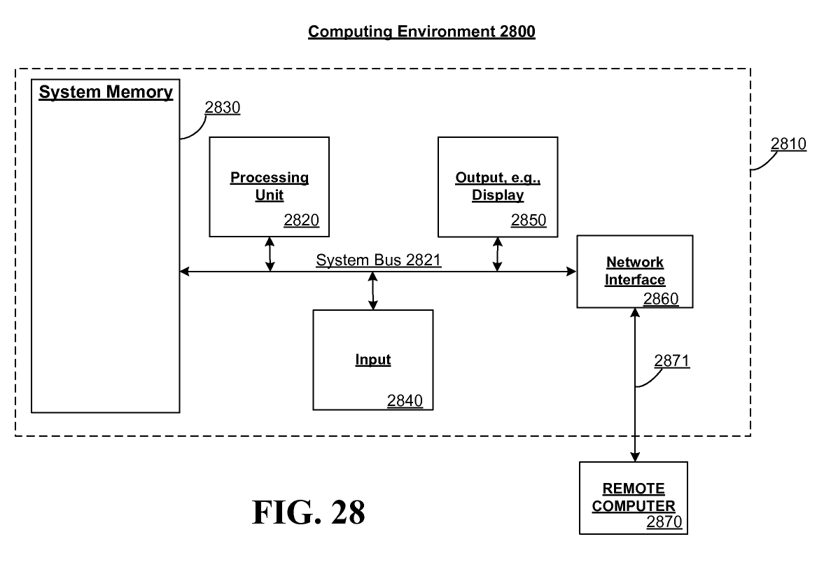

As mentioned, various embodiments described herein apply to any device wherein it may be desirable to perform pointing based services. It should be understood, therefore, that handheld, portable and other computing devices and computing objects of all kinds are contemplated for use in connection with the various embodiments described herein, i.e., anywhere that a device may request pointing based services. Accordingly, the below general purpose remote computer described below in FIG. 28 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer-executable instructions, such as program modules, being executed by one or more computers, such as client workstations, servers or other devices. Those skilled in the art will appreciate that network interactions may be practiced with a variety of computer system configurations and protocols.

FIG. 28 thus illustrates an example of a suitable computing system environment 2800 in which one or more of the embodiments may be implemented, although as made clear above, the computing system environment 2800 is only one example of a suitable computing environment and is not intended to suggest any limitation as to the scope of use or functionality of any of the embodiments. Neither should the computing environment 2800 be interpreted as having any dependency or requirement relating to any one or combination of components illustrated in the exemplary operating environment 2800.

With reference to FIG. 28, an exemplary remote device for implementing one or more embodiments herein can include a general purpose computing device in the form of a handheld computer 2810. Components of handheld computer 2810 may include, but are not limited to, a processing unit 2820, a system memory 2830, and a system bus 2821 that couples various system components including the system memory to the processing unit 2820.

Computer 2810 typically includes a variety of computer readable media and can be any available media that can be accessed by computer 2810. The system memory 2830 may include computer storage media in the form of volatile and/or nonvolatile memory such as read only memory (ROM) and/or random access memory (RAM). By way of example, and not limitation, memory 2830 may also include an operating system, application programs, other program modules, and program data.

A user may enter commands and information into the computer 2810 through input devices 2840 A monitor or other type of display device is also connected to the system bus 2821 via an interface, such as output interface 2850. In addition to a monitor, computers may also include other peripheral output devices such as speakers and a printer, which may be connected through output interface 2850.

The computer 2810 may operate in a networked or distributed environment using logical connections to one or more other remote computers, such as remote computer 2870. The remote computer 2870 may be a personal computer, a server, a router, a network PC, a peer device or other common network node, or any other remote media consumption or transmission device, and may include any or all of the elements described above relative to the computer 2810. The logical connections depicted in FIG. 28 include a network 2871, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and advertising architectures, the underlying concepts may be applied to any network system and any computing device or system in which it is desirable to derive information about surrounding points of interest.

There are multiple ways of implementing one or more of the embodiments described herein, e.g., an appropriate API, tool kit, driver code, operating system, control, standalone or downloadable software object, etc. which enables applications and services to use the pointing based services. Embodiments may be contemplated from the standpoint of an API (or other software object), as well as from a software or hardware object that provides pointing platform services in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While the various embodiments have been described in connection with the preferred embodiments of the various figures, it is to be understood that other similar embodiments may be used or modifications and additions may be made to the described embodiment for performing the same function without deviating therefrom. Still further, one or more aspects of the above described embodiments may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A portable electronic device, comprising:
a positional component for receiving position information as a function of a location of the portable electronic device; and
at least one processor configured to process the position information to determine at least one identifier of at least one three-dimensional (3-D) space associated with the location of the portable electronic device and to request content based on intent information determined for the portable electronic device and the at least one identifier.

2. The device of claim 1, further comprising:
a directional component that outputs direction information as a function of an orientation of the portable electronic device.

3. The device of claim 2, wherein the at least one processor is configured to determine a subset of items of interest relative to candidate items of interest within the at least one 3-D space as a function of at least the positional information and the direction information.

4. The device of claim 3, wherein the at least one processor is configured to request the content based on a selection of an item of interest and the at least one identifier.

5. The device of claim 3, wherein the at least one processor is configured to request the content based on a scan of an encoding associated with an item of interest and the at least one identifier.

6. The device of claim 3, wherein the at least one processor is configured to request the content based on a keyword received as input by the device and the at least one identifier.

7. The device of claim 1, wherein the at least one processor is further configured to request the content based on the intent information and the at least one identifier from at least one network service.

8. The device of claim 1, wherein the at least one processor is further configured to receive a content package based on the request for the content from the at least one network service.

9. The device of claim 8, further comprising:
at least one of a display for displaying graphical content from the content package or a speaker for rendering audio content from the content package.

10. The device of claim 1, wherein the at least one processor is further configured to receive a content package based on the request for the content from the at least one network service.

11. The device of claim 1, wherein the at least one processor automatically requests the content upon receiving the intent information and the at least one identifier.

12. The device of claim 1, wherein the directional component is a digital compass that outputs the direction information.

13. A method, comprising:
determining at least one place in which a portable device is located based on location information determined for the device, the location information representing a position of the device;
interacting with at least one item of interest in the at least one place;
requesting a price comparison for the at least one item of interest in the at least one place from a network service including requesting based on the at least one place; and
receiving results of the request for the price comparison modified as a function of the at least one place.

14. The method of claim 13, wherein the receiving includes receiving results including at least one additional or modified price added or modified based on the at least one place.

15. The method of claim 13, wherein the receiving includes receiving results adhering to at least one price matching rule set for the at least one place.

16. The method of claim 13, wherein the interacting includes a scanning of at least one bar code associated with the at least one item of interest.

17. The method of claim 13, wherein the interacting includes identifying the at least one item of interest with at least one keyword.

18. The method of claim 13, wherein the interacting includes orientating the device toward the at least one item of interest and determining direction information associated with the orientation of the device.

19. The method of claim 13, wherein the interacting includes pointing the device in a direction defining a pointing line generally towards items of interest in the at least one place and determining a set of candidate items of interest as a subset of items of interest that substantially intersect with the pointing line.

20. A method, comprising:
receiving positional information measured by a device as a function of a location of the device;
determining at least one identifier of at least one retail establishment associated with the positional information; and
based on the at least one identifier, transmitting customized content associated with a brand of the at least one retail establishment to the device for display.
